(19) United States
(12) Patent Application Publication
(10) Pub. No.: US 2010/0039982 A1
(43) Pub. Date: Feb. 18, 2010

(54) Wireless Communication Device, Communication System, Communication Control Method, and Program

(76) Inventors: Takeshi Itagaki, Tokyo (JP); Katsutoshi Itoh, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/537,821

(22) Filed: Aug. 7, 2009

(30) Foreign Application Priority Data
Aug. 14, 2008 (JP) P2008-208842

(51) Int. Cl. H04B 7/14; H04W 40/00

(52) U.S. Cl. 370/315; 370/338

(57) ABSTRACT

A wireless communication device includes a control unit that controls data communication, and a memory that stores communication data. The control unit controls a switch between a direct link path that is a direct communication path with a communication party, and a relay-point-routed path that is a communication path routed via a relay point. The control unit transmits a communication path switch request to the communication party, and on condition of reception of an acceptance response from the communication party, the control unit starts data communication using a switched communication path.

### BACKGROUND OF THE INVENTION

1. Field of the Invention

The present invention relates to a wireless communication device, a communication system, a communication control method, and a program. More specifically, the present invention relates to a wireless communication device, a communication system, a communication control method, and a program, with which communication is performed using both communication routed via an access point and direct communication not routed via the access point.

2. Description of the Related Art

The wireless LAN standard (802.11) specifies an ad-hoc mode which performs direct communication between wireless communication devices, and an infrastructure mode as a communication mode which performs communication via an access point.

In the infrastructure mode which performs communication via an access point, the access point that relays communication coordinates the access timings of a plurality of wireless communication devices that are present in a wireless network. On the other hand, in the ad-hoc mode which performs direct communication between wireless communication devices, communication is performed directly between the wireless communication devices, and the access timing is determined between the wireless communication devices. A technique according to the related art which discloses these communication nodes is disclosed in, for example, Japanese Unexamined Patent Application Publication No. 2005-117458.

While the infrastructure mode that is a mode of communication via an access point suffers from a drawback in that the throughput decreases in comparison to the ad-hoc mode, the infrastructure mode has an advantage in that each wireless terminal under control can connect to a wired LAN or the Internet. On the other hand, while the ad-hoc mode in which wireless terminals directly communicate with each other has an advantage in that there is no overhead due to the access point relay and hence the throughput increases, the ad-hoc mode suffers from a drawback in that it is not possible to connect to a wired LAN or the Internet.

As a new communication scheme that can exploit the advantages of these two modes, a TDLS (Tunneled Direct Link Setup) scheme is currently being defined as a new standard, 802.11z. According to this scheme, a direct communication link (direct link) is setup between wireless terminals to allow for direct communication while maintaining the infrastructure mode. In addition, a mechanism has been also proposed with which after a direct link is setup, paths (access-point-routed path and direct link path) used for performing transmission to the communication party can be switched as appropriate.

However, if an access-point-routed path and a direct link path are switched over while communication is executed between two communication devices, cases may arise in which data frames transmitted on the new path reach the communication party earlier than data frames transmitted on the old path. It should be noted that frames and packets are regarded as synonymous, and mean units of data communication.

If data frames transmitted on the new path reach the communication party earlier than data frames transmitted on the old path, the order of frames received at the data receiving device becomes altered, which hinders proper data communications. This phenomenon occurs due to such factors as a delay in relay operation routed via an access point, or a retransmission wait due to a deterioration in the transmission characteristics of the old path or the like.

The disarrangement of the order of received frames due to a path switch will be described with reference to FIG. 1. FIG. 1 shows, from its left-hand side, a wireless communication device (STA 1) serving as a data transmitting terminal, an access point (AP) that performs a communication relay process, and a wireless communication device (STA 2) serving as a data receiving terminal.

The wireless communication device (STA 1) first executes communication with the wireless communication device (STA 2) via the access point (AP). Thereafter, by setting up a direct link, the wireless communication device (STA 1) and the wireless communication device (STA 2) communicate directly with each other, without going through the access point (AP).

The numerals attached beside each data frame (=packet) transmission indicate the transmit order of packets from the wireless communication device (STA 1). The wireless communication device (STA 1) first transmits packets 1, 2, and 3 to the wireless communication device (STA 2) via the access point (AP). Thereafter, by setting up a direct link, the wireless communication device (STA 1) transmits packets 4, 5, and 6 to the wireless communication device (STA 2), without going through the access point (AP).

When such data transmission is executed, for example, if a delay occurs in the access point (AP) relay path, a situation arises in which, as indicated by the order of packets received at the wireless communication device (STA 2) shown in the drawing, the packets 4, 5, and 6 transmitted after switching to the direct link path reach the wireless communication device (STA 2) earlier, and the packets 1, 2, and 3 transmitted at an earlier timing are received later, so the order of frames becomes altered.

As a technique according to the related art that addresses this problem, for example, a measure is devised in the standardization of 802.11s. According to this measure, serial sequence numbers specifying the order of packets corresponding to transmit packets are assigned to headers further above the normal MAC header. However, since this technique makes it necessary to assign new sequence numbers in addition to assigning sequence numbers to the normal MAC header, there is a problem in that the processing load on the communication device increases, leading to a decrease in communication efficiency.

### SUMMARY OF THE INVENTION

It is thus desirable to provide a wireless communication device, a communication system, a communication control method, and a program, with which disarrangement of the order of received data due to a path switch can be overcome in the case of a configuration where communication involving a path switch between an access-point (AP)-routed path and a direct link path is performed between communication devices.

According to an embodiment of the present invention, there is provided a wireless communication device including a control unit that controls data communication, and a memory that stores communication data, in which the control unit controls a switch between a direct link path that is a direct communication path with a communication party, and a relay-point-routed path that is a communication path routed via a relay point, and the control unit transmits a communication path switch request to the communication party, and on condition of reception of an acceptance response from the communication party, the control unit starts data communication using a switched communication path.

Further, in the wireless communication device according to an embodiment of the present invention, after transmitting the communication path switch request to the communication party, the control unit accumulates data to be transmitted in the memory, and on condition of reception of an acceptance response from the communication party, the control unit transmits the data to be transmitted which has been accumulated in the memory, via a switched communication path.

Further, in the wireless communication device according to an embodiment of the present invention, the control unit transmits a path end frame, which indicates the last data transmitted on a currently used communication path, to the communication party, and transmits the communication path switch request after transmitting the path end frame.

Further, in the wireless communication device according to an embodiment of the present invention, the control unit transmits a data frame storing, in its appended header, information indicating the last data transmitted on a currently used communication path, to the communication party, and transmits the communication path switch request after transmitting the data frame.

Further, in the wireless communication device according to an embodiment of the present invention, the control unit transmits a data frame storing, in its appended header, information indicating the last data transmitted on a currently used communication path, to the communication party as the communication path switch request, and on condition of reception of an acceptance response from the communication party, the control unit starts data communication using a switched communication path.

Further, in the wireless communication device according to an embodiment of the present invention, the control unit transmits the communication path switch request to the communication party by using the direct link path that is the direct communication path with the communication party.

Further, according to an embodiment of the present invention, there is provided a wireless communication device including a control unit that controls data communication, in which the control unit controls a switch between a direct link path that is a direct communication path with a communication party, and a relay-point-routed path that is a communication path routed via a relay point, and the control unit returns a path switch acceptance response after receiving a communication path switch request from the communication party, and after returning the path switch acceptance response, the control unit discards a data frame from a path used before the switch.

Further, according to an embodiment of the present invention, there is provided a wireless communication device including a control unit that controls data communication, in which the control unit controls a switch between a direct link path that is a direct communication path with a communication party, and a relay-point-routed path that is a communication path routed via a relay point, and the control unit returns a path switch acceptance response after receiving a communication path switch request from the communication party, on condition of reception of an end frame from a path used before the switch, or elapse of a wait time since reception of the communication path switch request.

Further, in the wireless communication device according to an embodiment of the present invention, the control unit returns the path switch acceptance response on condition of reception of a data frame storing information indicating an end frame in its appended header.

Further, according to an embodiment of the present invention, there is provided a communication system including a plurality of wireless communication devices that transmit and receive data, the plurality of wireless communication devices having a first wireless communication device and a second wireless communication device, in which the first wireless communication device transmits a communication path switch request to the second wireless communication device that is a communication party, and starts data transmission using a switched path on condition of reception of an acceptance response from the second wireless communication device, and the second wireless communication device returns a path switch acceptance response after receiving the communication path switch request from the first wireless communication device, and after returning the path switch acceptance response, the second wireless communication device discards a data frame from a path used before the switch.

Further, according to an embodiment of the present invention, there is provided a communication system including a plurality of wireless communication devices that transmit and receive data, the plurality of wireless communication devices having a first wireless communication device and a second wireless communication device, in which the first wireless communication device transmits a communication path switch request to the second wireless communication device that is a communication party, and starts data transmission using a switched path on condition of reception of an acceptance response from the second wireless communication device, and the second wireless communication device returns a path switch acceptance response after receiving the communication path switch request from the first wireless communication device, on condition of reception of an end frame from a path used before the switch, or elapse of a wait time since reception of the communication path switch request.

Further, according to an embodiment of the present invention, there is provided a communication control method which is executed by a wireless communication device, including the step of controlling a switch between a direct link path that is a direct communication path with a communication party, and a relay-point-routed path that is a communication path routed via a relay point, in which the controlling of a switch includes transmitting a communication path switch request to the communication party, and starting data transmission using a switched path, on condition of reception of an acceptance response from the communication party.

Further, according to an embodiment of the present invention, there is provided a communication control method which is executed by a wireless communication device, including the step of controlling a switch between a direct link path that is a direct communication path with a communication party, and a relay-point-routed path that is a communication path routed via a relay point, in which the controlling of a switch includes receiving a communication path switch request from the communication party, returning a path switch acceptance response, and discarding a data frame from a path used before the switch, after returning the path switch acceptance response.

Further, according to an embodiment of the present invention, there is provided a communication control method which is executed by a wireless communication device, including the step of controlling a switch between a direct link path that is a direct communication path with a communication party, and a relay-point-routed path that is a communication path routed via a relay point, in which the controlling of a switch includes receiving a communication path switch request from the communication party, and returning a path switch acceptance response, on condition of reception of an end frame from a path used before the switch, or elapse of a wait time since reception of the communication path switch request.

Further, according to an embodiment of the present invention, there is provided a program for causing a wireless communication device to execute a communication control, including the step of causing a control unit to control a switch between a direct link path that is a direct communication path with a communication party, and a relay-point-routed path that is a communication path routed via a relay point, in which the controlling of a switch includes transmitting a communication path switch request to the communication party, and starting data transmission using a switched path, on condition of reception of an acceptance response from the communication party.

Further, according to an embodiment of the present invention, there is provided a program for causing a wireless communication device to execute a communication control, including the step of causing a control unit to control a switch between a direct link path that is a direct communication path with a communication party, and a relay-point-routed path that is a communication path routed via a relay point, in which the controlling of a switch includes receiving a communication path switch request from the communication party, returning a path switch acceptance response, and discarding a data frame from a path used before the switch, after returning the path switch acceptance response.

Further, according to an embodiment of the present invention, there is provided a program for causing a wireless communication device to execute a communication control, including the step of causing a control unit to control a switch between a direct link path that is a direct communication path with a communication party, and a relay-point-routed path that is a communication path routed via a relay point, in which the controlling of a switch includes receiving a communication path switch request from the communication party, and returning a path switch acceptance response, on condition of reception of an end frame from a path used before the switch, or elapse of a wait time since reception of the communication path switch request.

According to an embodiment of the present invention, a first communication device transmits a communication path switch request to a second communication device that is a communication party, and starts data transmission using the switched path on condition of reception of a path switch acceptance response. The second communication device that has received the communication path switch request returns a path switch acceptance response, and after returning the path switch acceptance response, the second communication device discards data frames transmitted from a path used before the switch. Alternatively, upon receiving the communication path switch request, the second communication device returns a path switch acceptance response after receiving an end frame from a path used before the switch. According to this configuration, data can be processed in an order that coincides with the order of data transmission, without causing disarrangement of the order of data received on the data receiving side.

It should be noted that the program according to an embodiment of the present invention is a program that can be provided to a computer system capable of executing a variety of program codes via a storage medium or communication medium that is provided in a computer-readable format. By providing such a program in a computer-readable format, processes corresponding to the program are realized on the computer system.

Other objects, features, and advantages of the present invention will become apparent from the following detailed description of embodiments of the present invention and the accompanying drawings. It should be noted that the term system as used in this specification refers to a logical collection of a plurality of devices, and is not limited to one in which the constituent devices are located within the same housing.

### BRIEF DESCRIPTION OF THE DRAWINGS

FIG. 1 is a diagram illustrating disarrangement of the order of received frames due to a path switch;

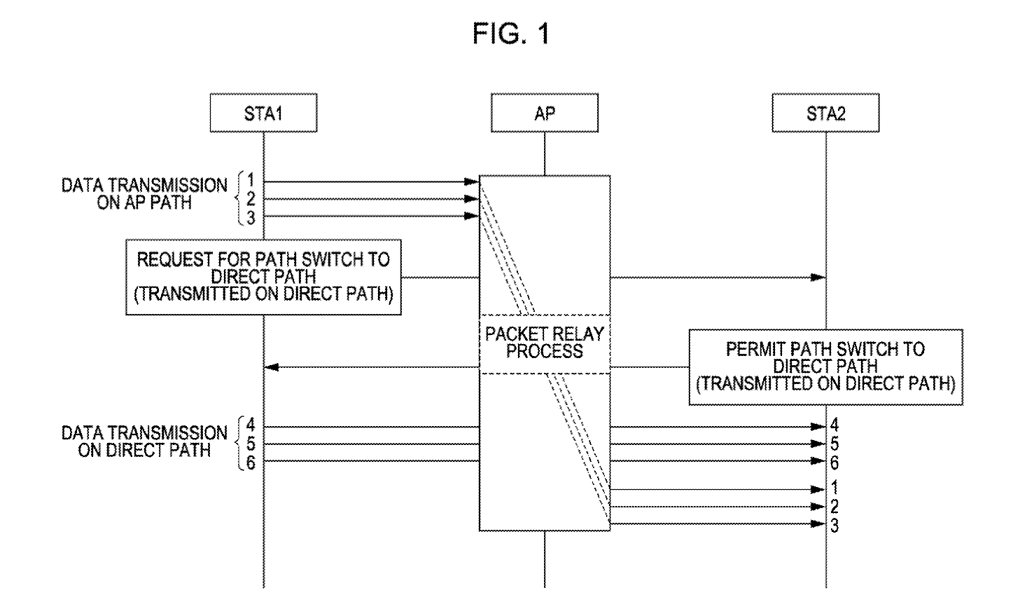

FIG. 2 is a diagram illustrating a wireless communication system according to an embodiment of the present invention;

FIG. 3 is a diagram showing a configuration example of a wireless communication device according to an embodiment of the present invention;

FIG. 4 is a diagram showing the outlines of a communication processing sequence according to an embodiment of the present invention;

FIG. 5 is a diagram showing a flowchart illustrating the communication sequence and processing between individual devices in a DLS registration process according to an embodiment of the present invention;

FIG. 6 is a diagram illustrating the communication sequence and processing between individual devices which are performed in a path switch process according to an embodiment of the present invention;

FIG. 7 is a diagram illustrating the communication sequence and processing between individual devices which are performed in a path switch process according to an embodiment of the present invention;

FIG. 8 is a diagram illustrating the communication sequence and processing between individual devices which are performed in a path switch process according to an embodiment of the present invention;

FIG. 9 is a diagram illustrating the communication sequence and processing between individual devices which are performed in a path switch process according to an embodiment of the present invention;

FIG. 10 is a diagram illustrating the communication sequence and processing between individual devices which are performed in a path switch process according to an embodiment of the present invention;

FIG. 11 is a diagram illustrating the communication sequence and processing between individual devices which are performed in a path switch process according to an embodiment of the present invention;

FIG. 12 is a diagram illustrating the communication sequence and processing between individual devices which are performed in a path switch process according to an embodiment of the present invention;

FIG. 13 is a diagram illustrating the communication sequence and processing between individual devices which are performed in a path switch process according to an embodiment of the present invention; and

FIG. 14 is a diagram illustrating the communication sequence and processing between individual devices which are performed in a path switch process according to an embodiment of the present invention.

### DESCRIPTION OF THE PREFERRED EMBODIMENTS

Hereinbelow, a wireless communication device, a communication system, a communication control method, and a program will be described in detail with reference to the drawings.

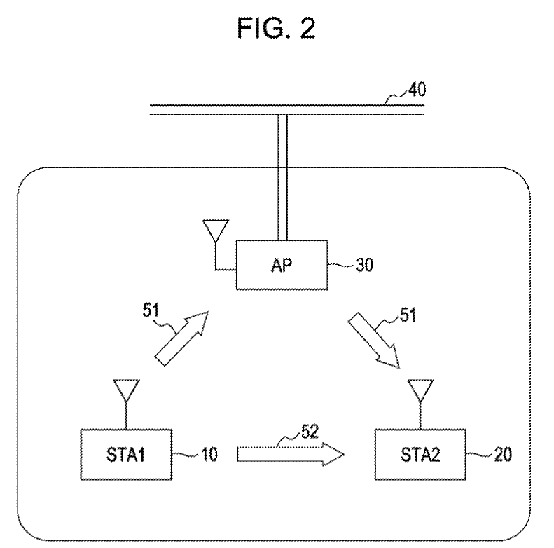

A wireless communication system according to an embodiment of the present invention will be described with reference to FIG. 2. FIG. 2 shows a wireless communication device (STA 1) 10 and a wireless communication device (STA 2) 20 as two wireless terminals that perform data communication, and further-an access point (AP) 30 that executes a process of relaying communication between the wireless communication devices.

The access point (AP) 30 may have the same general configuration as that employed in the related art, and may not have any special function. In addition to the normal operation of a wireless LAN, the wireless communication device (STA 1) 10 and the wireless communication device (STA 2) 20 have a direct link path setting function according to an embodiment of the present invention. It is assumed that the wireless communication device (STA 1) 10 and the wireless communication device (STA 2) 20 have completed in establishing an association as a connection request with the access point (AP) 30, and thus an AP-routed path 51 that connects the wireless communication device (STA 1) 10 to the wireless communication device (STA 2) 20 via the access point (AP) 30 can be used.

In the following description of embodiments, the wireless communication device (STA 1) 10 is set as the data transmitting side, and the wireless communication device (STA 2) 20 is set as the data receiving side. When the process of DLS (Direct Link Setup) as a setup process for performing direct communication between wireless communication devices is completed, it becomes possible to use a direct link path 52 shown in FIG. 2 which directly connects between the wireless communication device (STA 1) 10 and the wireless communication device (STA 2) 20.

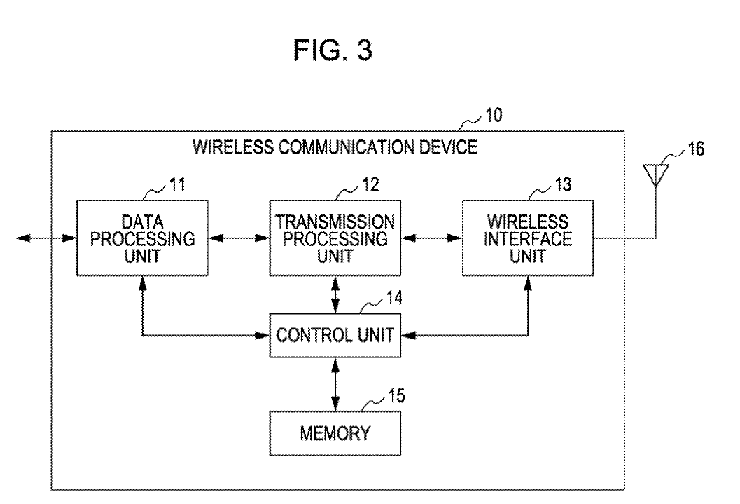

FIG. 3 is a block diagram showing a configuration of the wireless communication device (STA 1) 10 shown in FIG. 2. It should be noted that the wireless communication device (STA 2) 20 also have the same structure. As shown in FIG. 3, the wireless communication device 10 has a data processing unit 11, a transmission processing unit 12, a wireless interface unit 13, a control unit 14, a memory 15, and an antenna 16.

The data processing unit 11 creates packets storing communication data. The transmission processing unit 12 performs such processing as appending headers or error detection codes to the packets generated by the data processing unit 11, and provides the processed data to the wireless interface unit 13. The wireless interface unit 13 converts the data received from the transmission processing unit 12 into a modulating signal and sends the modulating signal via the antenna 16.

In the data receiving operation, for data received via the antenna 16, the wireless interface unit 13 performs demodulation of the received signal, and the transmission processing unit 12 performs analysis of its header and passes the resulting data to the data processing unit 11. The data processing unit acquires communication data from packets. The control unit 14 performs centralized control of the processing in each of the above-mentioned component units. In addition, the control unit 14 acquires data stored in the memory 15, and provides the acquired data to the data processing unit 11 so that the data is converted into packet-stored data. Alternatively, the control unit 14 stores data acquired by the data processing unit 11 from packets, into the memory 15. In addition to communication data, a program for communication control is stored in the memory 15. The control unit 14 executes a communication control according to the program.

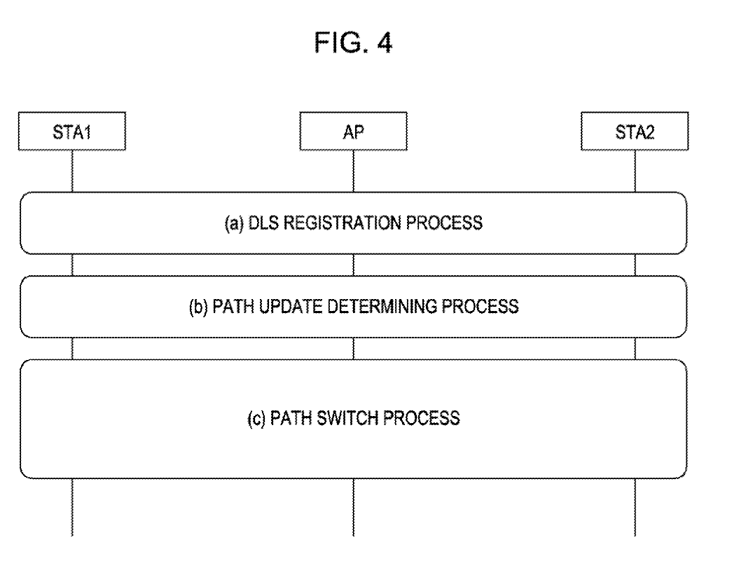

The outlines of a communication process sequence according to an embodiment of the present invention will be described with reference to FIG. 4. In the following description, the wireless communication device (STA 1) that transmits data, and the wireless communication device (STA 2) that receives data will be referred to in an abbreviated form as “STA 1” and “STA 2”, respectively.

As shown in FIG. 4, in a communication sequence according to an embodiment of the present invention, the following three processes are performed.

(a) DLS registration process

(b) Path update determining process

(c) Path switch process

These processes are performed under the control of the control unit in the wireless communication device.

(a) DLS registration process is a setup process for performing direct communication between wireless communication devices. In this DLS registration process, the wireless communication devices that execute direct communication (STA 1 and STA 2 in this example) encapsulate information on own device capability or the like in independent frames for mutual exchange, and registers the communication party with which communication is performed via a direct link.

After this DLS registration process is completed, it becomes possible for the STA 1 to transmit data to the STA 2 by selectively using both the AP-routed path and the direct link path.

(b) Path update determining process is a process in which, by using information related to the transmission quality of the direct link path and information related to the transmission quality of the AP-routed path which are monitored separately, it is evaluated which one of the direct link path and the AP-routed path is suitable as a path to be used for communication with the other party's terminal, and a path update to the more suitable path is determined.

(c) Path switch process represents a procedure performed when it is determined in the above-mentioned path update determining process to perform a path change from the currently used path to the other path, that is, a path change between the AP-routed path and the direct link path. In this procedure, the STA 1 notifies the STA 2 of the change of the path to be used, and receives an acceptance for the path change, while actually transmitting data to the STA 2. This procedure guarantees the order of data reaching the STA 2 from the STA 1. That is, a control is performed so that the STA 2 can receive packets in the order in which the packets are transmitted from the STA 1.

Hereinbelow, specific embodiments of the present invention will be described.

### 1. Embodiment 1

Hereinbelow, the following processes according to Embodiment 1 will be described in order.

(a) DLS registration process

(b) Path update determining process

(c) Path switch process

### 1a. DLS Registration Process

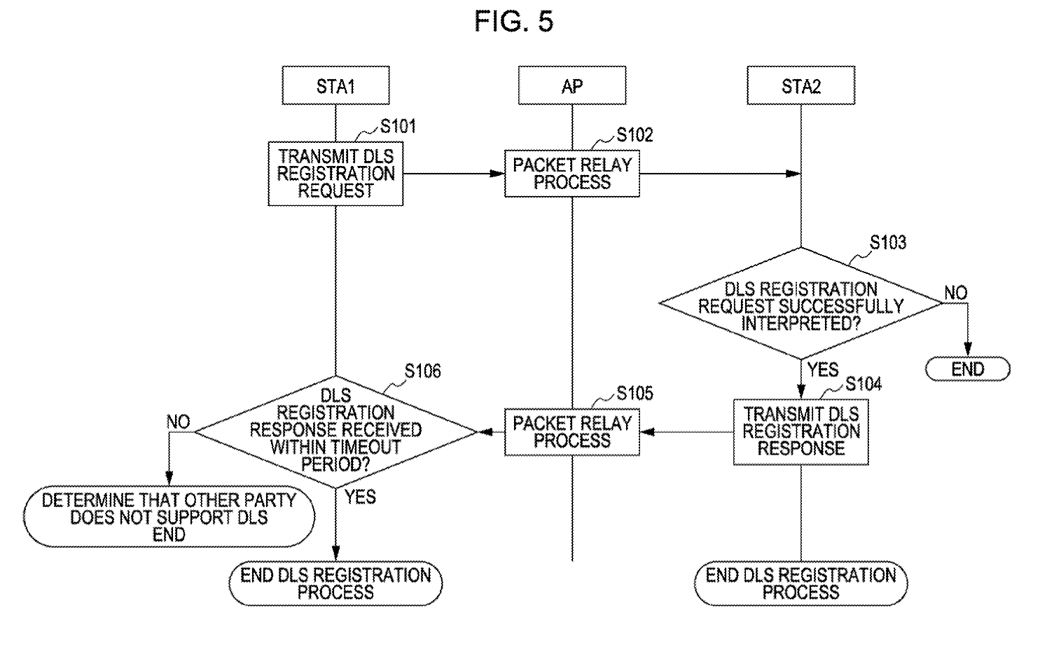

FIG. 5 is a diagram showing a flowchart illustrating the communication sequence and processing between individual devices in a DLS registration process according to this embodiment. In the drawing, the following devices are shown from the left-hand side:

a wireless communication device (STA 1) as a data transmitting terminal;

an access point (AP) as a communication relay device; and

a wireless communication device (STA 2) as a data receiving terminal.

The DLS registration process is a direct link setup process for performing direct communication between the wireless communication devices. In the DLS registration process, direct link setup request and response are transmitted/received as independent frames between the wireless communication devices. It should be noted that prior to the setting of a direct link, frames for the DLS registration process are transmitted/received via the access point (AP). At this time, the processing completes between the two STAs alone, without the access point (AP) relaying such transmission/reception being aware of the contents of the frames.

First, in step 3101, the STA 1 as a data transmitting-side terminal transmits to the STA 2 as a data receiving-side terminal a “DLS registration request” frame containing device capability information on the STA 1.

This frame is relayed by the access point (AP) before reaching the STA 2. If the STA 2 having received this frame can successfully interpret the contents of this frame (Yes in step S103), the STA 2 proceeds to step S104, and returns a “DLS registration response” frame to the STA 1 similarly via the AP. This frame is also an independent frame, and contains device capability information on the STA 2. Further, this frame contains a success/failure field that records information on permission/non-permission of a direct link setup in the STA 2, that is, information on the success/failure of DSL.

If the STA 2 is a device that does not support DLS, it is not possible for the STA 2 to interpret the contents of the DLS registration request frame received from the STA 1 (No in step S103). In this case, the DLS registration request frame received from the STA 1 is discarded within the STA 2, and the processing ends.

The “DLS registration response” frame, which is transmitted by the STA 2 to the STA 1 in step S104 after succeeding in interpreting the “DLS registration request” received from the STA 1, arrives at the STA 1 via the AP (step S105).

If the STA 1 can successfully receive the “DLS registration response” frame and interpret its contents (Yes in step S106), and further, the value of the success/failure field in the received frame indicates “DLS registration has succeeded”, the setup of DLS becomes complete.

If the STA 1 fails to receive the DLS registration response frame from the STA 2 within a preset timeout period, it is determined that the other party does not support DLS, and a direct link is not established. Once the setup of DLS is complete, from this point onward, the STA 1 and the STA 2 can transmit data to each other by selectively using both the AP-routed path and the direct link path. The subsequent processing is performed in parallel with data transmission/reception.

### 1b. Path Update Determining Process

As described above, the path update determining process is a process in which, by using information related to the transmission quality of the direct link path and information related to the transmission quality of the AP-routed path, it is evaluated which one of the direct link path and the AP-routed path is suitable as a path to be used for communication with the other party's terminal, and a path. update to the more suitable path is determined.

This path update determining process is performed in parallel with normal data transmission/reception. The transmitting-side terminal (STA 1 in this embodiment) takes the initiative in checking and evaluating the respective transmission characteristics of the AP-routed path (STA 1→AP→STA 2) and the direct link path (STA 1→STA 2) Although not particularly specified according to an embodiment of the present invention, the following procedure is conceivable as an example.

First, in corporation with the STA 2, the STA 1 makes the STA 2 measure and report the received channel power indicator (RCPI) of test probe traffic transmitted to the STA 2 via the AP-routed path. The STA 2 can obtain information on the transmission path quality based on the direct link by eavesdropping on the packets from the STA 1 to the AP, and obtain information on the transmission path quality of the latter half of the AP-routed path by measurement from the packets from the AP to the STA 2.

Then, conversely, the STA 1 makes the STA 2 transmit test probe traffic from the STA 2 to the STA 1, and makes a similar measurement, thereby obtaining information on the transmission path quality of the first half of the AP-routed path. Thereafter, the STA 1 estimates appropriate modulations from the results of measurements on the respective paths, and computes expected throughputs. Lastly, by comparing the expected throughputs computed for the respective paths, the STA 1 determines a path suitable for communication at the present time.

When the suitable path is updated as in this example, and the determined path differs from the path that is currently used, the STA 1 proceeds to a path switch process.

### 1c. Path Switch Process

The path switch process is a process in which a path switch is performed when it is determined in the path update determining process to perform a path change from the currently used path to the other path, that is, a path change between the AP-routed path and the direct link path. This process is executed while transmitting data to the STA 2 by the STA 1. This process represents a procedure in which the STA 1 notifies the STA 2 of the change of the path to be used, and receives an acceptance for the path change.

In the processing according to an embodiment of the present invention, at the time of this path switch procedure, a control is performed to guarantee the order of data reaching the STA 2 from the STA 1. That is, a control is performed so that packets can be received by the STA 2 in the order in which the packets are transmitted from the STA 1.

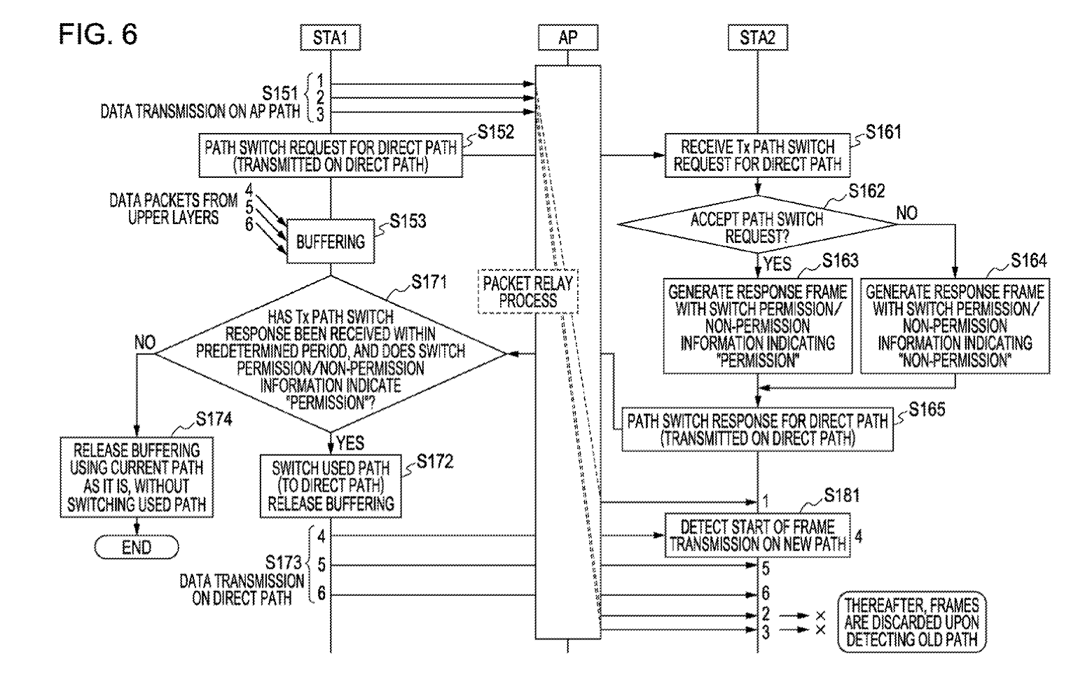

FIG. 6 is a diagram illustrating the communication sequence and processing between individual devices which are performed in the path switch process according to this embodiment. In the drawing, the following devices are shown from the left-hand side:

a wireless communication device (STA 1) as a data transmitting terminal;

an access point (AP) as a communication relay device; and

a wireless communication device (STA 2) as a data receiving terminal.

It should be noted that at the point of starting execution of this path switch process, the STA 1 is transmitting data to the STA 2 by using an AP-routed path. As indicated by step S151, packet frames 1, 2, and 3 are transmitted by using the AP-routed path. The access point (AP) shown in the drawing executes a packet relay process. The dotted lines in the AP shown in the drawing indicate the relay process. It should be noted that in the drawing, the AP-routed path is abbreviated as “AP path”, and a direct link path is abbreviated as “direct path”.

Upon determining a switch to the direct link path in the path update determining process described above, after finishing transmission of the last data frame (packet 3) to the STA 2, the STA 1 transmits a “Tx path switch request” frame in step S152.

The “Tx path switch request” frame is a frame used for the communication device on the data transmitting side to inform the communication device on the data receiving side of the intention to change a data transmission path. This frame is not a management frame but is a data frame containing signaling information in layers above the 802.11 MAC layer. In this embodiment, this frame is transmitted on the direct link path at all times.

Thereafter, the STA 1 on the data transmitting side does not perform data transmission until the STA 1 receives a “Tx path switch response” frame from the STA 2 on the data receiving side. Data packets passed down from upper layers during this period are buffered into a memory within the STA 1. As indicated by step S153, data packets 4, 5, and 6 passed down from upper layers are buffered into the memory within the STA 1. Therefore, after the transmission of the “path switch request” frame transmitted in step S152, the STA 1 suspends data transmission until the buffering is released (step S172 or S174).

On the other hand, the STA 2 on the data receiving side receives the “Tx path switch request” frame from the STA 1 in step S161. In step S162, the STA 2 interprets the contents of this frame, determines whether or not to accept the path switch request, and performs processing according to the determination.

If the STA 2 determines to accept the path switch request, the STA 2 proceeds to step S163, generates a “Tx path switch response” frame storing information indicating “permission” of acceptance of a path switch, and transmits the frame to the STA 1 in step S165. Like the path switch request frame, this frame is not a management frame but is a data frame containing signaling information in layers above the 802.11 MAC layer. In this embodiment, this frame is transmitted on the direct link path at all times.

On the other hand, if it is determined in step S162 not to accept the path switch request, the STA 2 proceeds to step S164, generates a “Tx path switch response” frame storing information indicating “non-permission” of acceptance of a path switch, and transmits the frame to the STA 1 in step S165.

The STA 1 on the data transmitting side waits for the “Tx path switch response” frame from the STA 2, and in step 5171, the STA 1 determines whether or not a “Tx path switch response” frame storing information indicating “permission” of acceptance of a path switch has been successfully received within a preset period.

If the “Tx path switch response” frame storing information indicating “permission” of acceptance of a path switch has been successfully received within the preset period, the STA 1 proceeds to step S172, and executes a switch of the path to be used from the AP-routed path to the direct link path. Then, in step S173, the STA 1 sequentially transmits the buffered data (packets 4, 5, and 6).

On the other hand, if reception of the “Tx path switch response” frame is not successfully confirmed even after elapse of a predetermined period following transmission of the “Tx path switch request” frame, or if a “Tx path switch response” frame storing information indicating “non-permission” of acceptance of a path switch is received, the STA 1 proceeds to step S174. In step S174, the STA 1 sequentially transmits the buffered data (packets 4, 5, and 6) by using the path (AP-routed path) that has been used so far as it is, without executing a path switch. That is, the STA 1 releases buffering, and resumes data transmission using the existing path.

After transmitting the “Tx path switch response” in step S165, the STA 2 on the data receiving side continues reception of data frames from the STA 1. However, if reception of even a single data frame transmitted from the STA 1 by using a new path is confirmed, thereafter, the STA 2 discards data frames transmitted from the STA 1 by using the old path. In the example shown in the drawing, in step S181, the STA 2 on the data receiving side receives a packet 4, which is the first data frame transmitted from the STA 1 by using the new path (direct link path).

In this case, after the reception of the packet 4, although the STA 2 receives and performs processing on packets 5 and 6 transmitted from the STA 1 by using the new path (direct link path), the STA 2 discards packets 2 and 3 transmitted by using the old path (AP-routed path).

As a result, packets are received on the data receiving side in an order according to the order in which the packets are transmitted (packets 1, 4, 5, and 6). It should be noted that while the packets 2 and 3 are discarded, the STA 2 may be set to execute a retransmission request to the STA 1 as necessary to receive the packets 2 and 3 later.

Through this processing, as shown in FIG. 6, even when some of the relayed frames from an existing path (AP-routed path) are passed by frames from the direct link path that is a new path, the order in which frames are received and processed by the STA 2 can be made to coincide with the order in which frame packets are transmitted from the STA 1. While the example described above with reference to FIG. 6 is directed to the case in which the existing path is the AP-routed path and the new path is the direct link path, the present invention is also applicable to a case in which the existing path is the direct link path and the new path is the AP-routed path.

### Embodiment 2

Next, a second embodiment of the present invention will be described. In Embodiment 2 as well, the following three processes described above with reference to FIG. 4 are sequentially executed.

(a) DLS registration process

(b) Path update determining process

(c) Path switch process

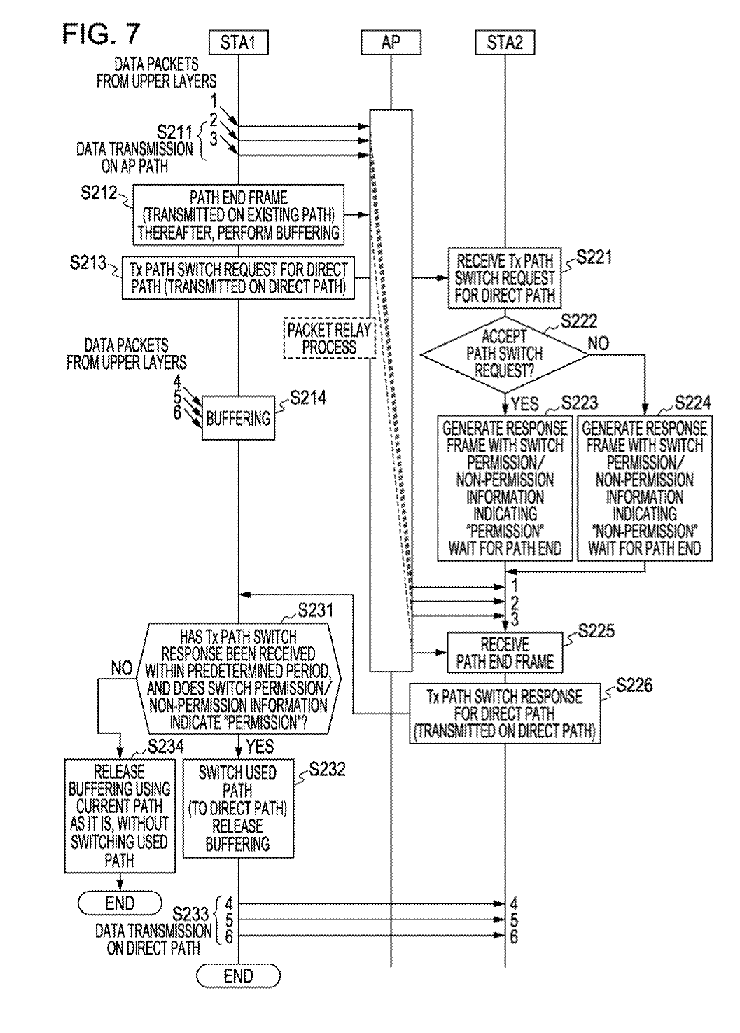

In Embodiment 2 as well, the (a) DLS registration process and the (b) path update determining process are executed in the same manner as described in Embodiment 1. Only the (c) path switch process differs from that in Embodiment 1. The (c) path switch process according to Embodiment 2 will be described below with reference to FIG. 7.

### Path Switch Process in Embodiment 2

FIG. 7 is a diagram illustrating the communication sequence and processing between individual devices which are performed in the path switch process according to this embodiment. In the drawing, the following devices are shown from the left-hand side:

a wireless communication device (STA 1) as a data transmitting terminal;

an access point (AP) as a communication relay device; and

a wireless communication device (STA 2) as a data receiving terminal.

It should be noted that at the point of starting execution of this path switch process, the STA 1 is transmitting data to the STA 2 by using an AP-routed path. As indicated by'step S211, packet frames 1, 2, and 3 are transmitted by using the AP-routed path. The access point (AP) shown in the drawing executes a packet relay process. The dotted lines in the AP shown in the drawing indicate the relay process. It should be noted that in the drawing, the AP-routed path is abbreviated as “AP path”, and a direct link path is abbreviated as “direct path”.

Upon determining a switch to the direct link path in the path update determining process described above, after finishing transmission of the last data frame (packet 3) to the STA 2, the STA 1 transmits a “path end” frame in step S212. This “path end” frame is transmitted by using the same path (AP-routed path) on which data packets have been transmitted so far.

Like the “Tx path switch request” frame used in Embodiment 1 described above, the “path end” frame is not a management frame but is a data frame containing signaling information in layers above the 802.11 MAC layer. This “path end” frame is a frame used for the communication device on the data transmitting side to inform the communication device on the data receiving side of the intention to change a data transmission path. The “path end” frame stores information indicating that this frame is the last frame transmitted by using the old path.

Thereafter, in step S213, the STA 1 transmits a “Tx path switch request” frame. In this embodiment, this frame is transmitted on the direct link path.

Thereafter, the STA 1 on the data transmitting side does not perform data transmission until the STA 1 receives a “Tx path switch response” frame from the STA 2 on the data receiving side. Data packets passed down from upper layers during this period are buffered into a memory within the STA 1. As indicated by step S214, data packets 4, 5, and 6 passed down from upper layers are buffered into the memory within the STA 1. Therefore, after the transmission of the “path switch request” frame transmitted in step S213, the STA 1 suspends data transmission until the buffering is released (step S232 or S234).

In a case where each of the communication devices STA 1 and STA 2 that execute transmission/reception of data, and the access point (AP) executes a QoS function, and has transmit queues individually for a plurality of access categories (ACs) or traffic IDs (TIDs) on the communication path, first, the presence/absence of packets in each queue at the time of a path update determination is monitored. Then, the above-described “Tx path switch request” and “path end” frames are transmitted for access categories (ACs) or traffic IDs (TIDs) in which transmit packets whose destination is the path switch target (STA 2 in this embodiment) exist.

If packets exist in a plurality of access category (AC) or traffic ID (TID) queues, “Tx path switch request” and “path end” are transmitted for all the corresponding ACs (or TIDs). It should be noted that if not even a single transmit packet exists with respect to the above destination, “Tx path switch request” and “path end” are transmitted for any one of arbitrary ACs (or TIDs).

If the above-mentioned two frames are transmitted for a plurality of ACs (or TIDS), data transmissions on the new path are buffered internally until “Tx path switch response” frames are received with respect to all the ACs (or TIDs) applied to the transmission of these frames.

On the other hand, the STA 2 on the data receiving side receives the “Tx path switch request” frame from the STA 1 in step S221. In step S222, the STA 2 interprets the contents of this frame, determines whether or not to accept the path switch request, and performs processing according to the determination.

If the STA 2 determines to accept the path switch request, the STA 2 proceeds to step S223, generates a “Tx path switch response” frame storing information indicating “permission” of acceptance of a path switch, and then waits for reception of a “path end” frame from the STA 1. The STA 2 having received the “path end” frame from the STA 1 in step S225 transmits the “Tx path switch response” frame to the STA 1 in step S226. In this embodiment, this frame is transmitted on the direct link path.

On the other hand, if it is determined in step S222 not to accept the path switch request, the STA 2 proceeds to step S224, and generates a “Tx path switch response” frame storing information indicating “non-permission” of acceptance of a path switch. Thereafter, after receiving the “path end” frame from the STA 1 in step S225, in step S226, the STA 2 transmits to the STA 1 the “Tx path switch response” frame storing information indicating “non-permission” of acceptance of a path switch.

At this time, in a case where each of the STAs and the AP supports a QoS function, upon receiving a “path end” frame with the same TID as the TID for which the “Tx path switch request” has been received, this frame is transmitted with the same TID as that TID. The STA 2 transmits a “Tx path switch response” frame also when the STA 2 has failed in receiving a “path end” frame within a predetermined period following reception of a “Tx path switch request”.

The STA 1 on the data transmitting side waits for the “Tx path switch response” frame from the STA 2, and in step S231, the STA 1 determines whether or not a “Tx path switch response” frame storing information indicating “permission” of acceptance of a path switch has been successfully received within a preset period.

If the “Tx path switch response” frame storing information indicating “permission” of acceptance of a path switch has been successfully received within the preset period, the STA 1 proceeds to step S232, and executes a switch of the path to be used from the AP-routed path to the direct link path. Then, in step S233, the STA 1 sequentially transmits the buffered data (packets 4, 5, and 6).

On the other hand, if reception of the “Tx path switch response” frame is not successfully confirmed even after elapse of a predetermined period following transmission of the “Tx path switch request” frame, or if a “Tx path switch response” frame storing information indicating “non-permission” of acceptance of a path switch is received, the STA 1 proceeds to step S234. In step S234, the STA 1 sequentially transmits the buffered data (packets 4, 5, and 6) by using the path (AP-routed path) that has been used so far as it is, without executing a path switch. That is, the STA 1 releases buffering, and resumes data transmission using the existing path.

At this time, in a case where each of the STAs and the AP supports a QoS function, buffering is released to start transmission on the new path only after it is confirmed that switch permission/non-permission information in “Tx path switch response” frames with respect to all the ACs (or TIDs) for which “Tx path switch request” has been transmitted indicates “permission”.

The order of packets received by the communication device STA 2 on the data receiving side is packets 1, 2, and 3, end frame, and packets 4, 5, and 6 in FIG. 7, which coincides with the order of their transmission. In this way, according to this embodiment, the communication device STA 2 on the data receiving side transmits a “Tx path switch response” frame indicating that a path switch has been accepted, on condition that the STA 2 has received the end frame on the old path. Thereafter, the STA 1 on the data transmitting side performs a path switch and sequentially transmits buffered packets. This configuration allows packets to be received on the data receiving side in the order in which these packets are transmitted.

While the example described above with reference to FIG. 7 is directed to the case in which the existing path is the AP-routed path and the new path is the direct link path, the present invention is also applicable to a case in which the existing path is the direct link path and the new path is the AP-routed path.

### Embodiment 3

Next, a third embodiment of the present invention will be described. In Embodiment 3 as well, the following three processes described above with reference to FIG. 4 are sequentially executed.

(a) DLS registration process

(b) Path update determining process

(c) Path switch process

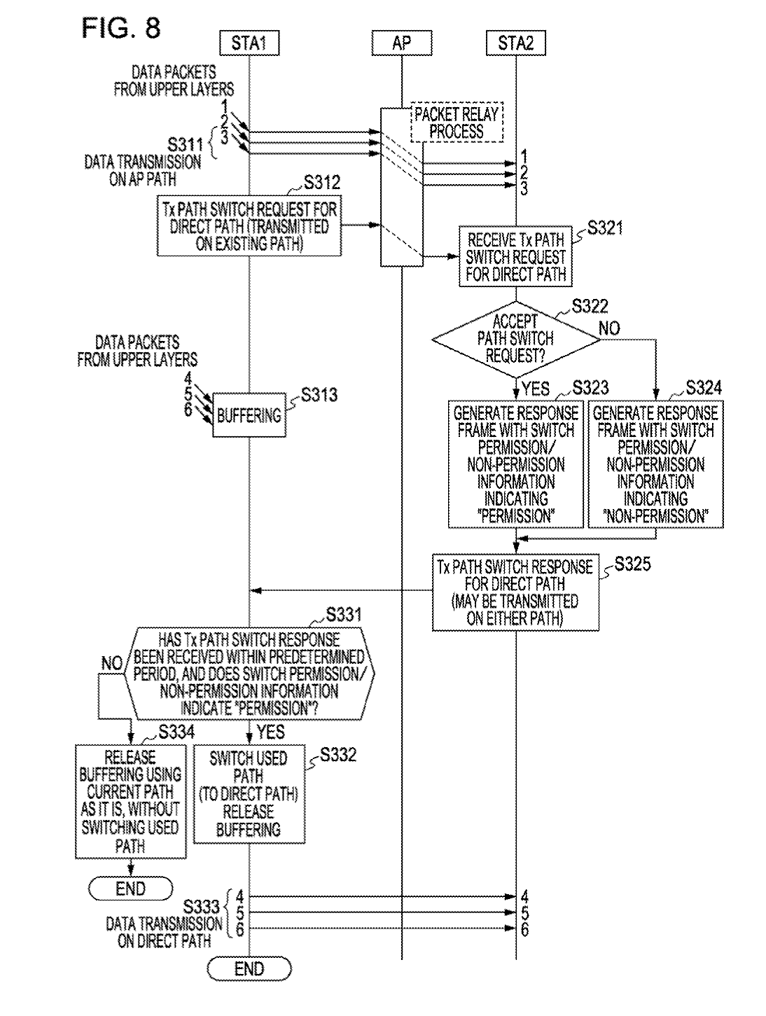

In Embodiment 3 as well, the (a) DLS registration process and the (b) path update determining process are executed in the same manner as described in Embodiment 1. Only the (c) path switch process differs from that in Embodiment 1. The (c) path switch process according to Embodiment 3 will be described below with reference to FIG. 8.

### Path Switch Process in Embodiment 3

FIG. 8 is a diagram illustrating the communication sequence and processing between individual devices which are performed in the path switch process according to this embodiment. In the drawing, the following devices are shown from the left-hand side:

a wireless communication device (STA 1) as a data transmitting terminal;

an access point (AP) as a communication relay device; and

a wireless communication device (STA 2) as a data receiving terminal.

It should be noted that at the point of starting execution of this path switch process, the STA 1 is transmitting data to the STA 2 by using an AP-routed path. As indicated by step S311, packet frames 1, 2, and 3 are transmitted by using the AP-routed path. The access point (AP) shown in the drawing executes a packet relay process. The dotted lines in the AP shown in the drawing indicate the relay process. It should be noted that in the drawing, the AP-routed path is abbreviated as “AP path”, and a direct link path is abbreviated as “direct path”.

Upon determining a switch to the direct link path in the path update determining process described above, after finishing transmission of the last data frame (packet 3) to the STA 2, the STA 1 transmits the same “path end” frame as that in each of Embodiments 1 and 2 described above, in step S312. In this embodiment, this frame doubles as the “path end” frame used in Embodiment 2, and is transmitted on the existing path (AP-routed path in this embodiment) at all times.

Thereafter, the STA 1 on the data transmitting side does not perform data transmission until the STA 1 receives a “Tx path switch response” frame from the STA 2 on the data receiving side. Data packets passed down from upper layers during this period are buffered into a memory within the STA 1. As indicated by step S313, data packets 4, 5, and 6 passed down from upper layers are buffered into the memory within the STA 1. Therefore, after the transmission of the “path switch request” frame transmitted in step S312, the STA 1 suspend data transmission until the buffering is released (step S332 or S334).

In a case where each of the communication devices STA 1 and STA 2 that execute transmission/reception of data, and the access point (AP) has a QoS function, and has transmit queues individually for a plurality of access categories (ACs) or traffic IDs (TIDs) on the communication path, first, the presence/absence of packets in each queue at the time of a path update determination is monitored. Then, the above-described “Tx path switch request” and “path end” frames are transmitted for access categories (ACs) or traffic IDs (TIDs) in which transmit packets whose destination is the path switch target (STA 2 in this embodiment) exist.

If packets exist in a plurality of access category (AC) or traffic ID (TID) queues, “Tx path switch request” and “path end” are transmitted for all the corresponding ACs (or TIDs). It should be noted that if not even a single transmit packet exists with respect to the above destination, “Tx path switch request” and “path end” are transmitted for any one of arbitrary ACs (or TIDs).

If the above-mentioned two frames are transmitted for a plurality of ACs (or TIDs), data transmissions on the new path are buffered internally until “Tx path switch response” frames are received with respect to all the ACs (or TIDs) applied to the transmission of these frames.

On the other hand, the STA 2 on the data receiving side receives the “Tx path switch request” frame from the STA 1 in step S321. In step S322, the STA 2 interprets the contents of this frame, determines whether or not to accept the path switch request, and performs processing according to the determination.

If the STA 2 determines to accept the path switch request, the STA 2 proceeds to step S323, and generates a “Tx path switch-response” frame storing information indicating “permission” of acceptance of a path switch. Thereafter, in step S325, the STA 2 transmits the “Tx path switch response” frame to the STA 1.

On the other hand, if it is determined in step S322 not to accept the path switch request, the STA 2 proceeds to step S324, and generates a “Tx path switch response” frame storing information indicating “non-permission” of acceptance of a path switch. Thereafter, in step S325, the STA 2 transmits to the STA 1 the “Tx path switch response” frame storing information indicating “non-permission” of acceptance of a path switch.

At this time, in a case where each of the STAs and the AP supports a QoS function, upon receiving a “path end” frame with the same TID as the TID for which the “Tx path switch request” has been received, this frame is transmitted with the same TID as that TID.

The STA 1 on the data transmitting side waits for the “Tx path switch response” frame from the STA 2, and in step S331, the STA 1 determines whether or not a “Tx path switch response” frame storing information indicating “permission” of acceptance of a path switch has been successfully received within a preset period.

If the “Tx path switch response” frame storing information indicating “permission” of acceptance of a path switch has been successfully received within the preset period, the STA 1 proceeds to step S332, and executes a switch of the path to be used from the AP-routed path to the direct link path. Then, in step S333, the STA 1 sequentially transmits the buffered data (packets 4, 5, and 6).

On the other hand, if reception of the “Max path switch response” frame is not successfully confirmed even after elapse of a predetermined period following transmission of the “Tx path switch request” frame, or if a “Tx path switch response” frame storing information indicating “non-permission” of acceptance of a path switch is received, the STA 1 proceeds to step S334. In step S334, the STA 1 sequentially transmits the buffered data (packets 4, 5, and 6) by using the path (AP-routed path) that has been used so far as it is, without executing a path switch. That is, the STA 1 releases buffering, and resumes data transmission using the existing path.

At this time, in a case where each of the STAs and the AP supports a QoS function, buffering is released to start transmission on the new path only after it is confirmed that switch permission/non-permission information in “Tx path switch response” frames with respect to all the ACs (or TIDs) for which the “Tx path switch request” has been transmitted indicates “permission”.

Although this embodiment is similar to Embodiment 2, the difference resides in that the STA 1 on the data transmitting side transmits a “Tx path switch request” by using an existing path (AP-routed path), and this frame doubles as a “path end” frame on the existing path (AP-routed path). Therefore, upon receiving the “Tx path switch request” frame, the STA 2 on the data receiving side can interpret this frame as a path end frame, and immediately transmit a “Tx path switch response” frame. In this embodiment, the number of frames transmitted at the time of a path switch can be reduced by one in comparison to Embodiment 2.

While the example described above with reference to FIG. 8 is directed to the case in which the existing path is the AP-routed path and the new path is the direct link path, the present invention is also applicable to a case in which the existing path is the direct link path and the new path is the AP-routed path.

### Embodiment 4

Next, a fourth embodiment of the present invention will be described. In Embodiment 4 as well, the following three processes described above with reference to FIG. 4 are sequentially executed.

(a) DLS registration process

(b) Path update determining process

(c) Path switch process

### 4a. DLS Registration Process in Embodiment 4

While the DLS registration process in Embodiment 4 is basically the same process as that in Embodiment 1, in this embodiment, after a direct link connecting between the STA 1 and the STA 2 is established, an extension header is attached to each packet transmitted and received between the two STAs (STA 1 and STA 2), in addition to the 802.11 MAC header.

Each extension header records the following information:

information indicating whether or not the corresponding packet is the last data packet on the currently used path (end information).

The STA 1 on the data transmitting side records this information in the extension header and transmits the packet.

The STA 2 on the receiving side analyzes this extension header, and removes this extension header before passing the packet to upper layer protocols.

### 4b. Path Update Determining Process in Embodiment 4

The (b) path update determining process is executed as the same process as that described with reference to Embodiment 1.

### 4c. Path Switch Process in Embodiment 4

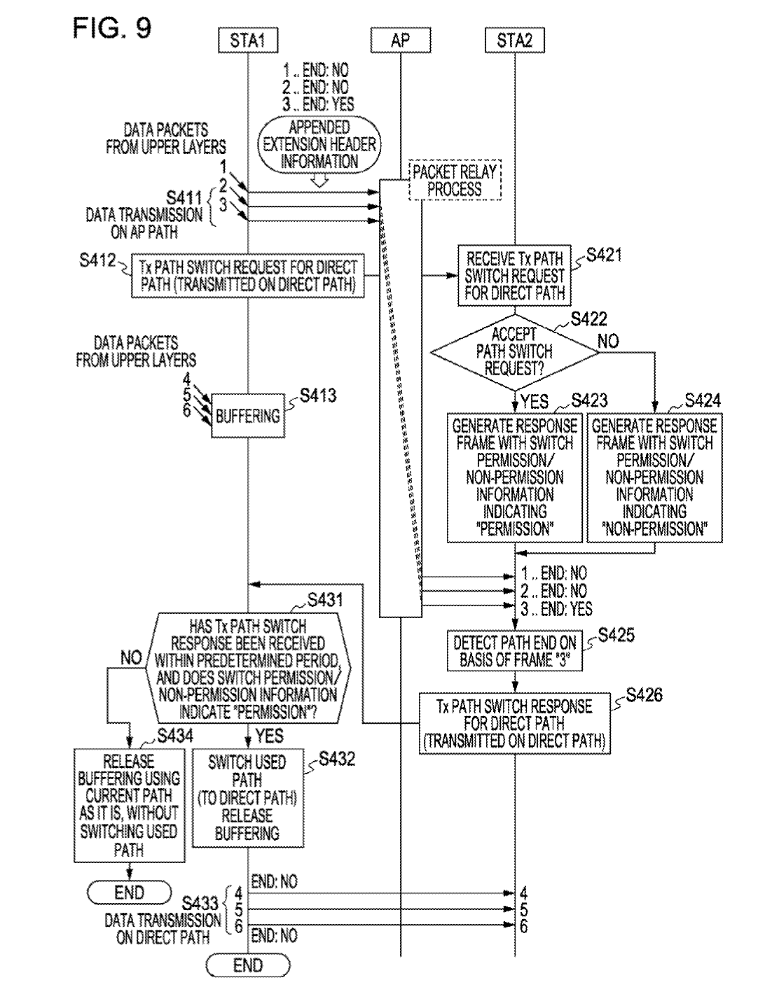

The path switch process in Embodiment 4 will be described with reference to FIG. 9.

FIG. 9 is a diagram illustrating the communication sequence and processing between individual devices which are performed in the path switch process according to this embodiment. In the drawing, the following devices are shown from the left-hand side:

a wireless communication device (STA 1) as a data transmitting terminal;

an access point (AP) as a communication relay device; and

a wireless communication device (STA 2) as a data receiving terminal.

It should be noted that at the point of starting execution of this path switch process, the STA 1 is transmitting data to the STA 2 by using an AP-routed path. As indicated by step 3411, packet frames 1, 2, and 3 are transmitted by using the AP-routed path. The access point (AP) shown in the drawing executes a packet relay process. The dotted lines in the AP shown in the drawing indicate the relay process. It should be noted that in the drawing, the AP-routed path is abbreviated as “AP path”, and a direct link path is abbreviated as “direct path”.

Although Embodiment 4 is similar to Embodiment 2 described above, Embodiment 4 differs in that no “path end” frame is necessary. When transmitting each data frame, the STA 1 that performs data transmission transmits each data frame while recording information indicating whether or not this data frame is the end frame on the currently used path, in the extension header of the data frame.

In the example shown in FIG. 9, among data frames 1, 2, and 3 transmitted on the AP-routed path in step S411, the data frame assigned a number of “3” is set as the end frame (the last frame on the current path). In this case, the STA 1 transmits the data frames after recording the following appended information in their respective extension headers.

End=No for data frame 1 (packet 1)

End=No for data frame 2 (packet 2)

End=Yes for data frame 3 (packet 3)

In this way, a special “path end” frame as that in Embodiment 2 is not used in Embodiment 4, and each data frame doubles as the “path end” frame used in Embodiment 2.

After transmitting a data frame recording appended information: End=Yes to the STA 2, the STA 1 transmits the same “Tx path switch request” frame as that in the above-described embodiments in step S412. This frame is transmitted on the direct path.

Thereafter, the STA 1 on the data transmitting side does not perform data transmission until the STA 1 receives a “Tx path switch response” frame from the STA 2 on the data receiving side. Data packets passed down from upper layers during this period are buffered into a memory within the STA 1. As indicated by step S413, data packets 4, 5, and 6 passed down from upper layers are buffered into the memory within the STA 1. Therefore, after the transmission of the “path switch request” frame transmitted in step S412, the STA 1 suspends data transmission until the buffering is released (step S432 or S434).

In a case where each of the communication devices STA 1 and STA 2 that execute transmission/reception of data, and the access point (AP) executes a QoS function, and has transmit queues individually for a plurality of access categories (ACs) or traffic IDs (TIDs) on the communication path, first, the presence/absence of packets in each queue at the time of a path update determination is monitored. Then, the above-described “Tx path switch request” and “end” frames are transmitted for access categories (ACs) or traffic IDs (TIDs) in which transmit packets whose destination is the path switch target (STA 2 in this embodiment) exist.

If packets exist in a plurality of access category (AC) or traffic ID (TID) queues, a “Tx path switch request” frame and an “end” frame are transmitted for all the corresponding ACs (or TIDs).

If the above-mentioned two frames are transmitted for a plurality of ACs (or TIDs), data transmissions on the new path are buffered internally until “Tx path switch response” frames are received with respect to all the ACs (or TIDs) applied to the transmission of these frames.

On the other hand, the STA 2 on the data receiving side receives the “Tx path switch request” frame from the STA 1 in step S421. In step S422, the STA 2 interprets the contents of this frame, determines whether or not to accept the path switch request, and performs processing according to the determination.

If the STA 2 determines to accept the path switch request, the STA 2 proceeds to step S423, generates a “Tx path switch response” frame storing information indicating “permission” of acceptance of a path switch, and then waits for reception of an “end” frame from the STA 1. In step S425, the STA 2 receives from the STA 1 a data frame 3 with appended information indicating that the frame is an end frame, and confirms the reception of the end frame. After this confirmation, in step S426, the STA 2 transmits the “Tx path switch response” frame to the STA 1. In this embodiment, this frame is transmitted on the direct link path.

On the other hand, if it is determined in step S422 not to accept the path switch request, the STA 2 proceeds to step S424, and generates a “Tx path switch response” frame storing information indicating “non-permission” of acceptance of a path switch. Thereafter, after receiving an “end” frame from the STA 1 in step S425, in step S426, the STA 2 transmits to the STA 1 the “Tx path switch response” frame storing information indicating “non-permission” of acceptance of a path switch.

The STA 1 on the data transmitting side waits for the “Tx path switch response” frame from the STA 2, and in step S431, the STA 1 determines whether or not a “Tx path switch response” frame storing information indicating “permission” of acceptance of a path switch has been successfully received within a preset period.

If the “Tx path switch response” frame storing information indicating “permission” of acceptance of a path switch has been successfully received within the preset period, the STA 1 proceeds to step S432, and executes a switch of the path to be used from the AP-routed path to the direct link path. Then, in step S433, the STA 1 sequentially transmits the buffered data (packets 4, 5, and 6).

On the other hand, if reception of the “Tx path switch response” frame is not successfully confirmed even after elapse of a predetermined period following transmission of the “Tx path switch request” frame, or if a “Tx path switch response” frame storing information indicating “non-permission” of acceptance of a path switch is received, the STA 1 proceeds to step S434. In step S434, the STA 1 sequentially transmits the buffered data (packets 4, 5, and 6) by using the path (AP-routed path) that has been used so far as it is, without executing a path switch. That is, the STA 1 releases buffering, and resumes data transmission using the existing path.

The order of packets received by the communication device STA 2 on the data receiving side is packets 1, 2, 3, 4, 5, and 6 in FIG. 9, which coincides with the order of their transmission. In this way, according to this embodiment, the communication device STA 2 on the data receiving side receives from the old path a data frame with appended information indicating that this frame is an end frame, and then transmits a “Tx path switch response” frame indicating that a path switch has been accepted. Thereafter, the STA 1 on the data transmitting side performs a path switch and sequentially transmits buffered packets. This configuration allows packets to be received on the data receiving side in the order in which these packets are transmitted.

While the example described above with reference to FIG. 9 is directed to the case in which the existing path is the AP-routed path and the new path is the direct link path, the present invention is also applicable to a case in which the existing path is the direct link path and the new path is the AP-routed path.

### Embodiment 5

Next, a fifth embodiment of the present invention will be described. In Embodiment 5 as well, the following three processes described above with reference to FIG. 4 are sequentially executed.

(a) DLS registration process

(b) Path update determining process

(c) Path switch process

### 5a. DLS Registration Process in Embodiment 5

While the DLS registration process in Embodiment 5 is basically the same process as that in Embodiment 1, in this embodiment, as in Embodiment 4, after a direct link connecting between the STA 1 and the STA 2 is established, an extension header is attached to each packet transmitted and received between the two STAs (STA 1 and STA 2), in addition to the 802.11 MAC header.

Each extension header records the following two pieces of information.

(1) Information indicating whether or not the corresponding packet is the last data packet on the currently used path (end information)

(2) Information indicating the path that is desired to be used for subsequent transmissions

The STA 1 on the data transmitting side records this information in the extension header and transmits the packet.

The STA 2 on the receiving side analyzes this extension header, and removes this extension header before passing the packet to upper layer protocols.

### 5b. Path Update Determining Process in Embodiment 5

The (b) path update determining process is executed as the same process as that described with reference to Embodiment 1.

### 5c. Path Switch Process in Embodiment 5

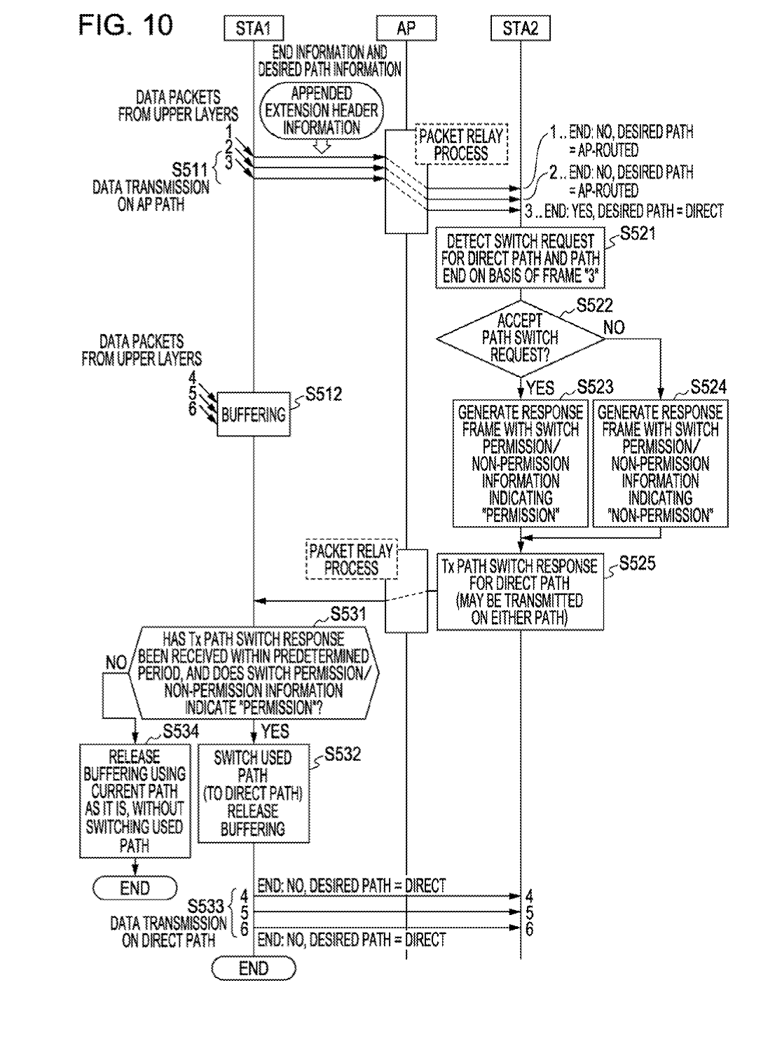

The path switch process in Embodiment 5 will be described with reference to FIG. 10.

FIG. 10 is a diagram illustrating the communication sequence and processing between individual devices which are performed in the path switch process according to this embodiment. In the drawing, the following devices are shown from the left-hand side:

a wireless communication device (STA 1) as a data transmitting terminal;

an access point (AP) as a communication relay device; and

a wireless communication device (STA 2) as a data receiving terminal.

It should be noted that at the point of starting execution of this path switch process, the STA 1 is transmitting data to the STA 2 by using an AP-routed path. As indicated by step S511, packet frames 1, 2, and 3 are transmitted by using the AP-routed path. The access point (AP) shown in the drawing executes a packet relay process. The dotted lines in the AP shown in the drawing indicate the relay process. It should be noted that in the drawing, the AP-routed path is abbreviated as “AP path”, and a direct link path is abbreviated as “direct path”.

Although Embodiment 5 is similar to Embodiment 2 described above, Embodiment 5 differs in that neither the “path end” frame nor the “Tx path switch request” frame is necessary. When transmitting each data frame, the STA 1 that performs data transmission transmits each data frame by recording the following two pieces of information in its extension header.

(1) Information indicating whether or not the corresponding frame is the end frame on the current path

(2) Information indicating the path that is desired to be used for subsequent transmissions

In the example shown in FIG. 10, among data frames 1, 2, and 3 transmitted on the AP-routed path in step S511, the data frame assigned a number of “3” is the end frame (the last frame on the current path). Appended information in which the path desired to be used for subsequent transmissions is set as the direct link path is recorded in this data frame. In this case, the STA 1 transmits the data frames after recording the following pieces of appended information in their respective extension headers.

End=No and Desired Path=AP-routed Path, for data frame 1 (packet 1)

End=No and Desired Path=AP-routed Path, for data frame 2 (packet 2)

End=Yes and Desired Path=Direct Link Path, for data frame 3 (packet 3).

In this way, special “path end” frame and “Tx path switch request” frame as those in Embodiment 2 are not used in Embodiment 5, and each data frame doubles as the “path end” frame and the “Tx path switch request” frame used in Embodiment 2.

Since the STA 2 on the data receiving side can learn the path though which a data frame has actually passed from the contents of the 802.11 MAC header, the STA 2 compares this against the desired path information within the extension header, and if this path differs from the desired path, the STA 2 performs the same operation as that performed when the “Tx path switch request” is received in Embodiment 2. In FIG. 10, the data frame with a number of “3” is the frame that doubles as a path switch request and a path end.

Thereafter, the STA 1 on the data transmitting side does not perform data transmission until the STA 1 receives a “Tx path switch response” frame from the STA 2 on the data receiving side. Data packets passed down from upper layers during this period are buffered into a memory within the STA 1. As indicated by step S512, data packets 4, 5, and 6 passed down from upper layers are buffered into the memory within the STA 1. Therefore, after the transmission of the data frame transmitted in step S511, the STA 1 suspends data transmission until the buffering is released (step S532 or S534).

On the other hand, the STA 2 on the data receiving side receives a data frame 3 from the STA 1 in step S521, and acquires information recorded in the extension header of the data frame 3, that is, the following appended information:

End=Yes, and Desired Path=Direct Link Path, thus confirming that this data frame is the end frame, and a path switch is desired.

In step S522, the STA 2 interprets the contents of this frame, determines whether or not to accept the path switch request, and performs processing according to the determination.

If the STA 2 determines to accept the path switch request, the STA 2 proceeds to step S523, and generates a “Tx path switch response” frame storing information indicating “permission” of acceptance of a path switch. Thereafter, in step S525, the STA 2 transmits the “Tx path switch response” frame to the STA 1. In this embodiment, this frame may be transmitted on either of the direct link path and the AP-routed path.

On the other hand, if it is determined in step S522 not to accept the path switch request, the STA 2 proceeds to step S524, and generates a “Tx path switch response” frame storing information indicating “non-permission” of acceptance of a path switch. Thereafter, in step S525, the STA 2 transmits to the STA 1 the “Tx path switch response” frame storing information indicating “non-permission” of acceptance of a path switch.

The STA 1 on the data transmitting side waits for the “Tx path switch response” frame from the STA 2, and in step S531, the STA 1 determines whether or not a “Tx path switch response” frame storing information indicating “permission” of acceptance of a path switch has been successfully received within a preset period.

If the “Tx path switch response” frame storing information indicating “permission” of acceptance of a path switch has been successfully received within the preset period, the STA 1 proceeds to step S532, and executes a switch of the path to be used from the AP-routed path to the direct link path. Then, in step S533, the STA 1 sequentially transmits the buffered data (packets 4, 5, and 6).

On the other hand, if reception of the “Tx path switch response” frame is not successfully confirmed even after elapse of a predetermined period, or if a “Tx path switch response” frame storing information indicating “non-permission” of acceptance of a path switch is received, the STA 1 proceeds to step S534. In step S534, the STA 1 sequentially transmits the buffered data (packets 4, 5, and 6) by using the path (AP-routed path) that has been used so far as it is, without executing a path switch. That is, the STA 1 releases buffering, and resumes data transmission using the existing path.

In the case described above with reference to FIG. 10, the data frame for switching desired path information and the data frame indicating a path end are the same frame. However, these data frames may not necessarily be the same frame. A setting is also possible in which only the intention of switching the desired path is transmitted by being appended to a preceding data frame, and the path end frame is transmitted later.

In this case, for example, the STA 2 on the data receiving side transmits a “Tx path switch response” frame also when, for example, the STA 2 has failed in receiving a data frame in which appended information indicating an end is recorded in its extension header, within a predetermined period following reception of a data frame in which information informing the intention of performing a “Tx path switch” is written in its extension header.

In a case where each of the STAs and the AP supports a QoS function, and has transmit queues individually for a plurality of access categories (ACs) or traffic IDs (TIDs) on the existing path, information indicating a change of desired path and an end is transmitted for all of the ACs (or TIDs) in which transmit packets whose destination is the path switch target (STA 2 in this embodiment) exist. If information indicating a change of desired path and an end is transmitted for a plurality of ACs (TIDs), data transmissions on the new path are buffered internally until “Tx path switch response” frames are received with respect to all the ACs (TIDs) for which such information has been transmitted.

The order of packets received by the communication device STA 2 on the data receiving side is packets 1, 2, 3, 4, 5, and 6 in FIG. 10, which coincides with the order of their transmission. In this way, according to this embodiment, the communication device STA 2 on the data receiving side receives from the old path a data frame with appended information indicating that the data frame is an end frame and that a path switch is desired, and then transmits a “Tx path switch response” frame indicating that a path switch has been accepted. Thereafter, the STA 1 on the data transmitting side performs a path switch and sequentially transmits buffered packets. This configuration allows packets to be received on the data receiving side in the order in which these packets are transmitted.

While the example described above with reference to FIG. 10 is directed to the case in which the existing path is the AP-routed path and the new path is the direct link path, the present invention is also applicable to a case in which the existing path is the direct link path and the new path is the AP-routed path.

### Embodiment 6

Next, a sixth embodiment of the present invention will be described. In Embodiment 6 as well, the following three processes described above with reference to FIG. 4 are sequentially executed.

(a) DLS registration process

(b) Path update determining process

(c) Path switch process

### 6a. DLS Registration Process in Embodiment 6

The DLS registration process in Embodiment 6 is basically the same process as that in Embodiment 1.

### 6b. Path Update Determining Process in Embodiment 6

While the (b) path update determining process described in Embodiment 1 is executed by the STA 1 on the data transmitting side, in Embodiment 6, the STA 2 on the data receiving side performs a path update determining process. The receiving-side terminal (STA 2) takes the initiative in checking and evaluating the respective transmission characteristics of an AP-routed path (STA 1→AP→STA 2) and a direct link path (STA 1→STA 2). On the receiving side as well, the transmission qualities of the respective paths can be estimated in the same manner as in Embodiment 1.

### 6c. Path Switch Process in Embodiment 6

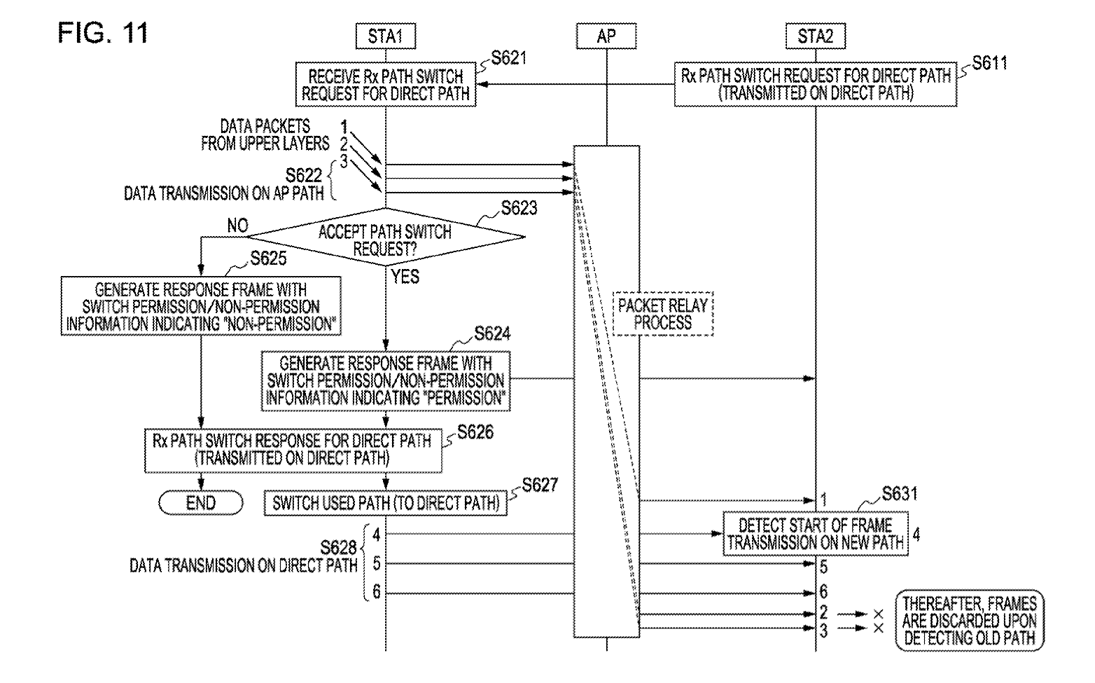

The path switch process in Embodiment 6 will be described with reference to FIG. 11.

FIG. 11 is a diagram illustrating the communication sequence and processing between individual devices which are performed in the path switch process according to this embodiment. In the drawing, the following devices are shown from the left-hand side:

a wireless communication device (STA 1) as a data transmitting terminal;

an access point (AP) as a communication relay device; and

a wireless communication device (STA 2) as a data receiving terminal.

It should be noted that at the point of starting execution of this path switch process, the STA 1 is transmitting data to the STA 2 by using an AP-routed path. As indicated by step S511, packet frames 1, 2, and 3 are transmitted by using the AP-routed path. The access point (AP) shown in the drawing executes a packet relay process. The dotted lines in the AP shown in the drawing indicate the relay process. It should be noted that in the drawing, the AP-routed path is abbreviated as “AP path”, and a direct link path is abbreviated as “direct path”.

In this embodiment, the STA 2 on the data receiving side determines a switch to the direct link path in the path update determining process. First, in step S611, the STA 2 on the data receiving side transmits a “Rx path switch request” frame to the STA 1 on the data transmitting side.

The “Rx path switch request” frame is a frame used for the communication device on the data receiving side to inform the communication device on the data transmitting side of the intention to change a data transmission path. This frame is not a management frame but is a data frame containing signaling information in layers above the 802.11 MAC layer. In this embodiment, this frame is transmitted on the direct link path at all times. It should be noted that since this request frame is encapsulated in a data frame, the frame reaches the other party without fail even when transmitted on an AP-routed path. Thereafter, the STA 2 waits for a “Rx path switch response” frame from the STA 1.

The STA 1 receives the “Rx path switch request” frame from the STA 2 in step S621. Then, in step S623, the STA 2 interprets the contents of this frame, determines whether or not to accept the path switch request, and performs processing according to the determination.

If the STA 1 determines to accept the path switch request, the STA 1 proceeds to step S624, and generates a “Rx path switch response” frame storing information indicating “permission” of acceptance of a path switch. Then, after performing transmission of the last data addressed to the STA 2 using the current path, in step S626, the STA 1 transmits the “Rx path switch response” frame to the STA 2. In this embodiment, this frame is transmitted on the direct link path. Like the path switch request frame, this frame is not a management frame but is a data frame containing signaling information in layers above the 802.11 MAC layer.

On the other hand, if it is determined in step S623 not to accept the path switch request, the STA 1 proceeds to step S625, and generates a “Rx path switch response” frame storing information indicating “non-permission” of acceptance of a path switch. Thereafter, in step S626, the STA 1 transmits to the STA 2 the “Rx path switch response” frame storing information indicating “non-permission” of acceptance of a path switch.

Thereafter, if the STA 1 has transmitted a “Rx path switch response” frame with switch permission/non-permission information set to indicate “permission”, the STA 1 switches the path to be used in step S627, and starts transmission on the new path in step S628. If the STA 1 has transmitted a “Rx path switch response” frame indicating “non-permission” of acceptance of a path switch, the STA 1 continues data transmission on the existing path.

After transmitting the “Rx path switch response”, the STA 2 on the data receiving side continues reception of data frames from the STA 1. However, if reception of even a single data frame transmitted from the STA 1 by using a new path is confirmed, thereafter, the STA 2 discards data frames transmitted from the STA 1 by using the old path.

In the example shown in FIG. 11, in step S631, the STA 2 on the data receiving side receives a packet 4, which is the first data frame transmitted from the STA 1 by using a new path (direct link path).

In this case, after the reception of the packet 4, although the STA 2 receives and performs processing on packets 5 and 6 transmitted from the STA 1 by using the new path (direct link path), the STA 2 discards packets 2 and 3 transmitted by using the old path (AP-routed path).

As a result, packets are received on the data receiving side in an order according to the order (packets 1, 4, 5, and 6) in which the packets are transmitted. It should be noted that while the packets 2 and 3 are discarded, the STA 2 may be set to execute a retransmission request to the STA 1 as necessary to receive the packets 2 and 3 later.

Through this processing, as shown in FIG. 11, even when some of the relayed frames from an existing path (AP-routed path) are passed by frames from the direct link path that is a new path, the order in which frames are received and processed by the STA 2 can be made to coincide with the order in which frame packets are transmitted from the STA 1.

While the example described above with reference to FIG. 11 is directed to the case in which the existing path is the AP-routed path and the new path is the direct link path, the present invention is also applicable to a case in which the existing path is the direct link path and the new path is the AP-routed path.

### Embodiment 7

Next, a seventh embodiment of the present invention will be described. In Embodiment 7 as well, the following three processes described above with reference to FIG. 4 are sequentially executed.

(a) DLS registration process

(b) Path update determining process

(c) Path switch process

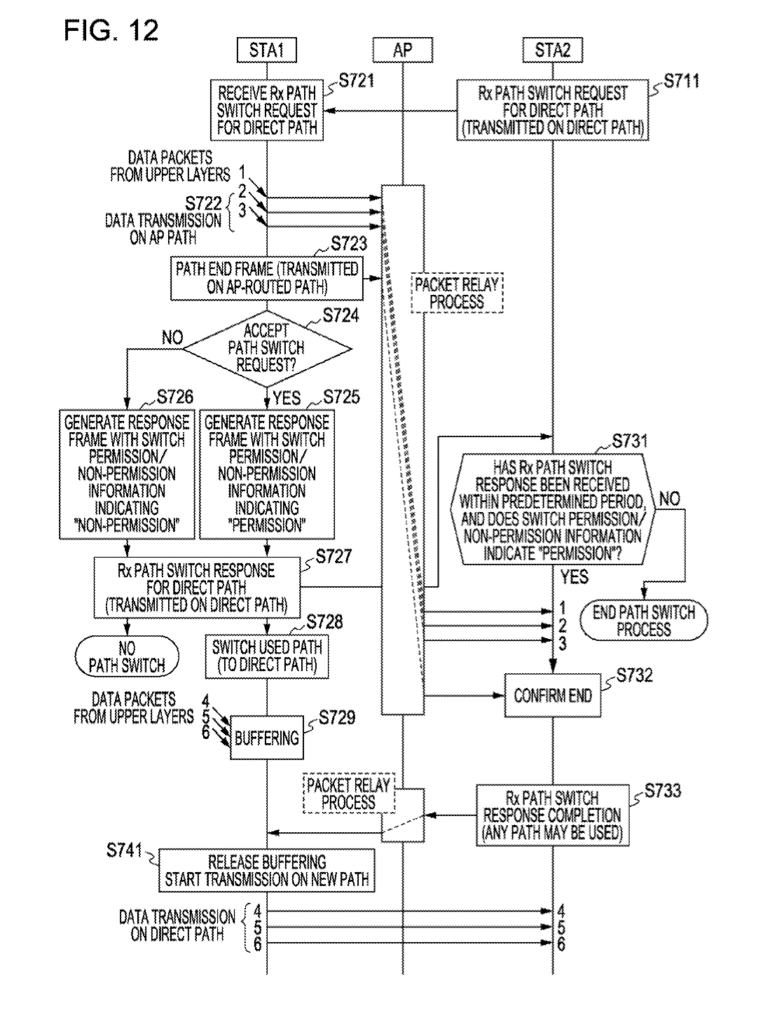

In Embodiment 7, the (a) DLS registration process and the (b) path update determining process are executed in the same manner as described in Embodiment 1. Only the (c) path switch process differs from that in Embodiment 1. The (c) path switch process according to Embodiment 7 will be described below with reference to FIG. 12.

### Path Switch Process in Embodiment 7

FIG. 12 is a diagram illustrating the communication sequence and processing between individual devices which are performed in the path switch process according to this embodiment. In the drawing, the following devices are shown from the left-hand side:

a wireless communication device (STA 1) as a data transmitting terminal;

an access point (AP) as a communication relay device; and

a wireless communication device (STA 2) as a data receiving terminal.

It should be noted that at the point of starting execution of this path switch-process, the STA 1 is transmitting data to the STA 2 by using an AP-routed path. As indicated by step S722, packet frames 1, 2, and 3 are transmitted by using the AP-routed path. The access point (AP) shown in the drawing executes a packet relay process. The dotted lines in the AP shown in the drawing indicate the relay process. It should be noted that in the drawing, the AP-routed path is abbreviated as “AP path”, and a direct link path is abbreviated as “direct path”.

In Embodiment 7 as well, as in Embodiment 6 described above, the STA 2 on the data receiving side determines a switch to the direct link path in the path update determining process. First, in step S711, the STA 2 on the data receiving side transmits a “Rx path switch request” frame to the STA 1 on the data transmitting side.

The STA 1 receives the “Rx path switch request” frame from the STA 2 in step S721. Thereafter, in step S723, the STA 1 transmits a “path end” frame indicating that this frame is the last frame on the existing path (AP-routed path).

Then, in step S724, the STA 2 interprets the contents of the “Rx path switch request” frame from the STA 2, determines whether or not to accept the path switch request, and performs processing according to the determination.

If the STA 1 determines to accept the path switch request, the STA 1 proceeds to step S725, and generates a “Rx path switch response” frame storing information indicating “permission” of acceptance of a path switch. Thereafter, in step S727, the STA 1 transmits the “Rx path switch response” frame to the STA 2. In this embodiment, this frame is transmitted on the direct link path. Like the path switch request frame, this frame is not a management frame but is a data frame containing signaling information in layers above the 802.11 MAC layer.

On the other hand, if it is determined in step S724 not to accept the path switch request, the STA 1 proceeds to step S726, and generates a “Rx path switch response” frame storing information indicating “non-permission” of acceptance of a path switch. Thereafter, in step S727, the STA 1 transmits to the STA 2 the “Rx path switch response” frame storing information indicating “non-permission” of acceptance of a path switch.

Thereafter, if the STA 1 has transmitted a “Rx path switch response” frame with switch permission/non-permission information indicating “permission”, the STA 1 switches the path to be used in step S728. Thereafter, the STA 1 does not perform data transmission until the STA 1 receives a “Rx path switch response completion” frame from the STA 2. Data packets passed down from upper layers during this period are buffered internally (step S729). Hence, the “path end” frame transmitted in step S723 is the last frame transmitted by the STA 1 by using an existing path.

In a case where each of the STAs and the AP supports a QoS function, and has transmit queues individually for a plurality of access categories (ACs) or traffic IDs (TIDs) on the existing path, first, the presence/absence of packets in each queue at the time when a determination of “permission” is made in response to a “Rx path switch request” is monitored. Then, “Rx path switch response” and “path end” frames are transmitted for ACs (or TIDs) in which transmit packets whose destination is the path switch target (STA 2 in this embodiment) exist.

If packets exist with respect to a plurality of AC (or TID) queues, a “Rx path switch response” and a “path end” are transmitted for all the corresponding ACs (or TIDs). If not even a single transmit packet exists with respect to the above destination, a “Rx path switch response” and a “path end” are transmitted for any one of arbitrary ACs (TIDs). If a response is transmitted for a plurality of ACs (TIDs), data transmissions on the new path are buffered internally until “Rx path switch response completion” frames are received with respect to all the ACs (TIDs) for which the response has been transmitted.

On the other hand, the STA 2 on the data receiving side receives the “Rx path switch response” frame from the STA 1, and upon confirming in step S731 that the path switch permission/non-permission information indicates “permission”, after waiting for reception of a “path end” frame in step S732, in step S733, the STA 2 transmits a “Rx path switch response completion” frame to the STA 1 again. This is a frame for informing that reception of the last frame on the existing path has been completed. This response confirmation frame may be transmitted by using either of the paths.

It should be noted that in a case where each of the STAs and the AP supports a QoS function, this frame is transmitted with the same TID as the TID for which the “Rx path switch response” has been received.

If it is determined in step S731 that the path switch permission/non-permission information indicates “non-permission”, the STA 2 determines that a path switch is not to be executed, and continuous data reception on the existing path.

The STA 1 on the data transmitting side transmits to the STA 2 a “Rx path switch response” frame storing information indicating “permission” of acceptance of a path switch. Upon receiving a “Rx path switch response completion” frame from the STA 2, in step S741, the STA 1 releases buffering and starts transmission on the new path. If the STA 1 has transmitted a “Rx path switch response” frame storing information indicating “non-permission” of acceptance of a path switch, the STA 1 continues data transmission on the existing path.

It should be noted that the STA 1 starts transmission on the new path also if a “Rx path switch response completion” frame has not been successfully received within a predetermined period after transmitting a “Rx path switch response” frame storing information indicating “permission” of acceptance of a path switch.

At this time, in a case where each of the STAs and the AP supports a QoS function, buffering is released to start transmission on the new path only after confirming reception of “Rx path switch response completion” frames with respect to all the ACs (TIDs) for which a “Rx path switch request” has been transmitted.

In this embodiment, after a path switch request is made from the data receiving side, and a path end frame on the old path is transmitted from the data transmitting side and the path end frame is received by the data receiving side, the data receiving side transmits a “Rx path switch response completion” frame to the data transmitting side (STA 1), and then data transmission using the switched path is performed. Therefore, as shown in FIG. 12, the order of frames received on the data receiving side (STA 2) is set as the order of transmission of data 1 to 6.

While the example described above with reference to FIG. 12 is directed to the case in which the existing path is the AP-routed path and the new path is the direct link path, the present invention is also applicable to a case in which the existing path is the direct link path and the new path is the AP-routed path.

### Embodiment 8

Next, an eighth embodiment of the present invention will be described. In Embodiment 8 as well, the following three processes described above with reference to FIG. 4 are sequentially executed.

(a) DLS registration process

(b) Path update determining process

(c) Path switch process

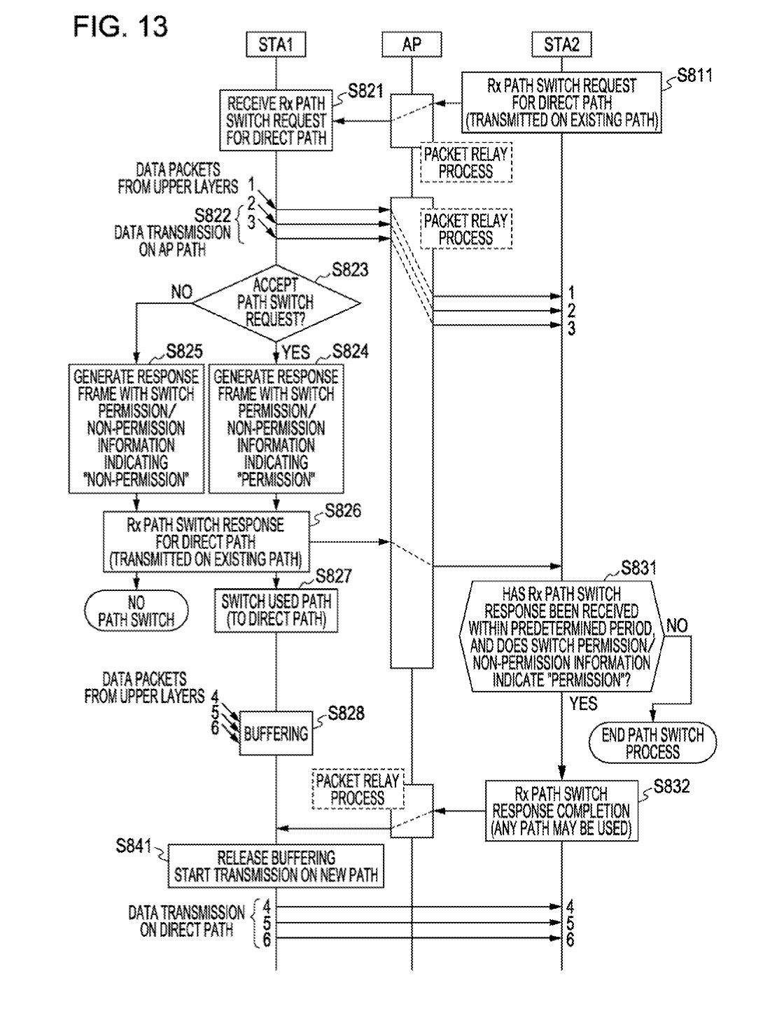

In Embodiment 8, the (a) DLS registration process and the (b) path update determining process are executed in the same manner as described in Embodiment 1. Only the (c) path switch process differs from that in Embodiment 1. The (c) path switch process according to Embodiment 8 will be described below with reference to FIG. 13.

### Path Switch Process in Embodiment 8

FIG. 13 is a diagram illustrating the communication sequence and processing between individual devices which are performed in the path switch process according to this embodiment. In the drawing, the following devices are shown from the left-hand side:

a wireless communication device (STA 1) as a data transmitting terminal;

an access point (AP) as a communication relay device; and

a wireless communication device (STA 2) as a data receiving terminal.

It should be noted that at the point of starting execution of this path switch process, the STA 1 is transmitting data to the STA-2 by using an AP-routed path. As indicated by step S822, packet frames 1, 2, and 3 are transmitted by using the AP-routed path. The access point (AP) shown in the drawing executes a packet relay process. The dotted lines in the AP shown in the drawing indicate the relay process. It should be noted that in the drawing, the AP-routed path is abbreviated as “AP path”, and a direct link path is abbreviated as “direct path”.

In Embodiment 8 as well, as in Embodiments 6 and 7 described above, the STA 2 on the data receiving side determines a switch to the direct link path in the path update determining process. First, in step S811, the STA 2 on the data receiving side transmits a “Rx path switch request” frame to the STA 1 on the data transmitting side. This frame is transmitted via an existing path (AP-routed path).

The STA 1 receives the “Rx path switch request” frame from the STA 2 in step S821. Then, in step S823, the STA 1 interprets the contents of the “Rx path switch request” frame from the STA 2, determines whether or not to accept the path switch request, and performs processing according to the determination. In this embodiment, the “path end” frame used in FIG. 7 is not transmitted.

If the STA 1 determines to accept the path switch request, after performing transmission of the last data addressed to the STA 2 using the current path, the STA 1 proceeds to step S824, and generates a “Rx path switch response” frame storing information indicating “permission” of acceptance of a path switch. Then, in step S826, the STA 1 transmits the “Rx path switch response” frame to the STA 2. In this embodiment, this frame is transmitted on the existing path (AP-routed path).

On the other hand, if it is determined in step S823 not to accept the path switch request, the STA 1 proceeds to step S825, and generates a “Rx path switch response” frame storing information indicating “non-permission” of acceptance of a path switch. Thereafter, in step S826, the STA 1 transmits to the STA 2 the “Rx path switch response” frame storing information indicating “non-permission” of acceptance of a path switch.

Thereafter, if the STA 1 has transmitted a “Rx path switch response” frame with switch permission/non-permission information indicating “permission”, the STA 1 switches the path to be used in step S827. Thereafter, the STA 1 does not perform data transmission until the STA 1 receives a “Rx path switch response completion” frame from the STA 2. Data packets passed down from upper layers during this period are buffered internally (step S828). Hence, the “Rx path switch response” frame transmitted in step S826 is the last frame transmitted by the STA 1 by using an existing path. This frame doubles as a “path end” frame.

In a case where each of the STAs and the AP supports a QoS function, and has transmit queues individually for a plurality of access categories (ACs) or traffic IDs (TIDs) on the existing path, first, the presence/absence of packets in each queue at the time when a determination of “permission” is made in response to a “Rx path switch request” is monitored. Then, a “Rx path switch response” frame is transmitted for ACs (or TIDs) in which transmit packets whose destination is the path switch target (STA 2 in this embodiment) exist.

If packets exist with respect to a plurality of AC (or TID) queues, a “Rx path switch response” is transmitted for all the corresponding ACs (TIDs). If not even a single transmit packet exists with respect to the above destination, a “Rx path switch response” is transmitted for any one of arbitrary ACs (TIDs). If a response is transmitted for a plurality of ACs (TIDs), data transmissions on the new path are buffered internally until “Rx path switch response completion” frames are received with respect to all the ACs (TIDs) for which the response has been transmitted.

On the other hand, the STA 2 on the data receiving side receives the “Rx path switch response” frame from the STA 1, and upon confirming in step S831 that the path switch permission/non-permission information indicates “permission”, in step S832, the STA 2 transmits a “Rx path switch response completion” frame to the STA 1. This is a frame for informing that reception of the last frame on the existing path has been completed. This response confirmation frame may be transmitted by using either of the paths.

It should be noted that in a case where each of the STAs and the AP supports a QoS function, this frame is transmitted with the same TID as the TID for which the “Rx path switch response” has been received.

If it is determined in step S831 that the path switch permission/non-permission information indicates “non-permission”, the STA 2 determines that a path switch is not to be executed, and continuous data reception on the existing path.

The STA 1 on the data transmitting side transmits to the STA 2 a “Rx path switch response” frame storing information indicating “permission” of acceptance of a path switch. Upon receiving a “Rx path switch response completion” frame from the STA 2, in step S841, the STA 1 releases buffering and starts transmission on a new path. If the STA 1 has transmitted a “Rx path switch response” frame storing information indicating “non-permission” of acceptance of a path switch, the STA 1 continues data transmission on the existing path.

It should be noted that the STA 1 starts transmission on the new path also if a “Rx path switch response completion” frame has not been successfully received within a predetermined period after transmitting a “Rx path switch response” frame storing information indicating “permission” of acceptance of a path switch.

At this time, in a case where each of the STAs and the AP supports a QoS function, buffering is released to start transmission on the new path only after confirming reception of “Rx path switch response completion” frames with respect to all the ACs (TIDs) for which a “Rx path switch request” has been transmitted.

According to this embodiment, after a path switch request is made from the data receiving side, and a “Rx path switch response” frame is transmitted on the old path from the data transmitting side and this frame is received on the data receiving side, a “Rx path switch response completion” frame is transmitted to the data transmitting side (STA 1), and then data transmission after a path switch process is performed. Therefore, as shown in FIG. 13, the order of frames received on the data receiving side (STA 2) is set as the order of transmission of data 1 to 6.

While the example described above with reference to FIG. 13 is directed to the case in which the existing path is the AP-routed path and the new path is the direct link path, the present invention is also applicable to a case in which the existing path is the direct link path and the new path is the AP-routed path.

### Embodiment 9

Next, a ninth embodiment of the present invention will be described. In Embodiment 9 as well, the following three processes described above with reference to FIG. 4 are sequentially executed.

(a) DLS registration process

(b) Path update determining process

(c) Path switch process

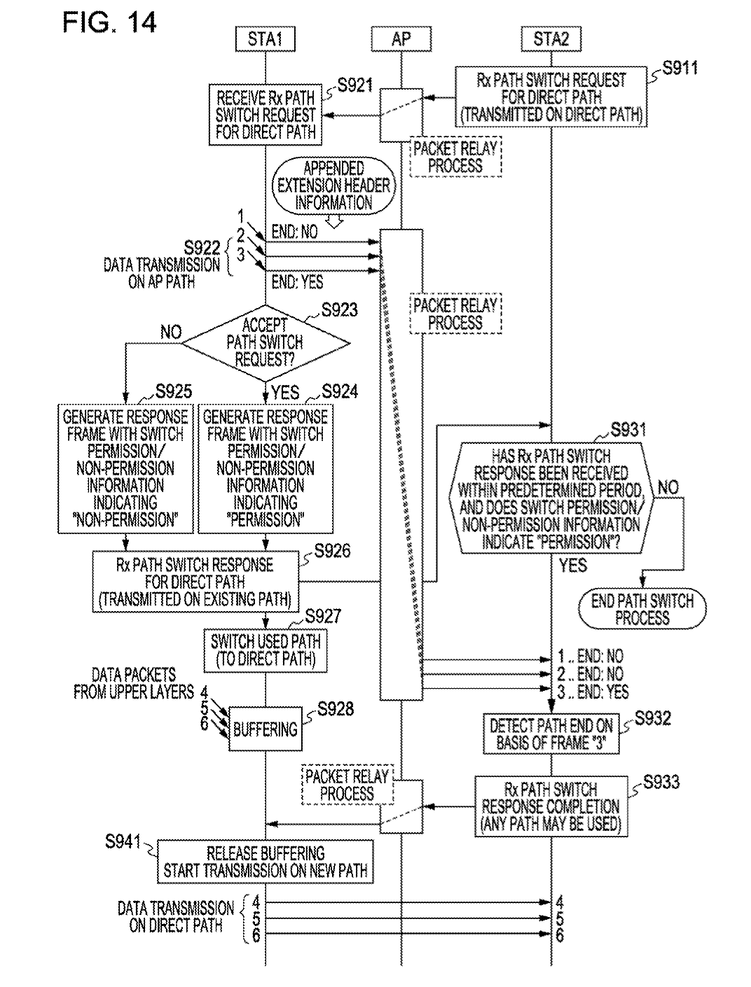

In Embodiment 9, the (a) DLS registration process and the (b) path update determining process are executed in the same manner as described in Embodiment 1. Only the (c) path switch process differs from that in Embodiment 1. The (c) path switch process according to Embodiment 9 will be described below with reference to FIG. 14.

### Path Switch Process in Embodiment 9

FIG. 14 is a diagram illustrating the communication sequence and processing between individual devices which are performed in the path switch process according to this embodiment. In the drawing, the following devices are shown from the left-hand side:

a wireless communication device (STA 1) as a data transmitting terminal;

an access point (AP) as a communication relay device; and

a wireless communication device (STA 2) as a data receiving terminal.

It should be noted that at the point of starting execution of this path switch process, the STA 1 is transmitting data to the STA 2 by using an AP-routed path. As indicated by step S922, packet frames 1, 2, and 3 are transmitted by using the AP-routed path. The access point (AP) shown in the drawing executes a packet relay process. The dotted lines in the AP shown in the drawing indicate the relay process. It should be noted that in the drawing, the AP-routed path is abbreviated as “AP path”, and a direct link path is abbreviated as “direct path”.

While Embodiment 9 is basically similar to Embodiment 7, in Embodiment 9, the STA 1 on the data transmitting side does not transmit a “path end” frame. The STA 1 records, in the extension header of a data frame, information indicating that this data frame is an end frame on the existing path, thus informing the STA 2 on the data receiving side to that effect.

In Embodiment 9 as well, as in Embodiments 6 to 8 described above, the STA 2 on the data receiving side determines a switch to the direct link path in the path update determining process. First, in step S911, the STA 2 on the data receiving side transmits a “Rx path switch request” frame to the STA 1 on the data transmitting side. This frame is transmitted via an existing path (AP-routed path).

The STA 1 receives the “Rx path switch request” frame from the STA 2 in step S921. Then, in step S923, the STA 1 interprets the contents of the “Rx path switch request” frame from the STA 2, determines whether or not to accept the path switch request, and performs processing according to the determination. In this embodiment, the “path end” frame used in FIG. 7 is not transmitted.

In S922 where the STA 1 performs data transmission addressed to the STA 2 using the current path, the STA 1 stores, in the extension header of the last data frame, information indicating that the data frame is an end frame, and transmits this data.

Thereafter, the STA 1 proceeds to step S924, and generates a “Rx path switch response” frame storing information indicating “permission” of acceptance of a path switch. Then, in step S926, the STA 1 transmits the “Rx path switch response” frame to the STA 2. In this embodiment, this frame is transmitted on the direct link path.

On the other hand, if it is determined in step S923 not to accept the path switch request, the STA 1 proceeds to step S925, and generates a “Rx path switch response” frame storing information indicating “non-permission” of acceptance of a path switch. Thereafter, in step S926, the STA 1 transmits to the STA 2 the “Rx path switch response” frame storing information indicating “non-permission” of acceptance of a path switch.

Thereafter, if the STA 1 has transmitted a “Rx path switch response” frame with switch permission/non-permission information indicating “permission”, the STA 1 switches the path to be used in step S927. Thereafter, the STA 1 does not perform data transmission until the STA 1 receives a “Rx path switch response completion” frame from the STA 2. Data packets passed down from upper layers during this period are buffered internally (step S928). Hence, the data frame 3 storing end information transmitted in step S922 is the last frame transmitted by the STA 1 by using an existing path. This frame doubles as a “path end” frame.

In a case where each of the STAs and the AP supports a QoS function, and has transmit queues individually for a plurality of access categories (ACs) or traffic IDs (TIDs), first, the presence/absence of packets in each queue at the time when a determination of “permission” is made in response to a “Rx path switch request” is monitored. Then, the “Rx path switch response” frame is transmitted for ACs (or TIDs) in which transmit packets whose destination is the path switch target (STA 2 in this embodiment) exist.

If packets exist with respect to a plurality of AC (or TID) queues, a “Rx path switch response” is transmitted for all the corresponding ACs (TIDs). If not even a single transmit packet exists with respect to the above destination, a “Rx path switch response” is transmitted for any one of arbitrary ACs (TIDs). If a response is transmitted for a plurality of ACs (TIDs), data transmissions on the new path are buffered internally until “Rx path switch response completion” frames are received with respect to all the ACs (TIDs) for which the response has been transmitted.

On the other hand, the STA 2 on the data receiving side receives the “Rx path switch response” frame from the STA 1, and upon confirming in step S931 that the path switch permission/non-permission information indicates “permission”, on the basis of appended header information in data frames from the existing path, the STA 2 checks for a frame storing information indicating a path end.

It should be noted that in a case where each of the STAs and the AP supports a QoS function, this frame is transmitted with the same TID as the TID for which the “Rx path switch response” has been received.

If it is determined in step S931 that the path switch permission/non-permission information indicates “non-permission”, the STA 2 determines that a path switch is not to be executed, and continuous data reception on the existing path.

The STA 1 on the data transmitting side transmits to the STA 2 a “Rx path switch response” frame storing information indicating “permission” of acceptance of a path switch. Upon receiving a “Rx path switch response completion” frame from the STA 2, in step S941, the STA 1 releases buffering and starts transmission on a new path. If the STA 1 has transmitted a “Rx path switch response” frame storing information indicating “non-permission” of acceptance of a path switch, the STA 1 continues data transmission on the existing path.

It should be noted that the STA 1 starts transmission on the new path also if a “Rx path switch response completion” frame has not been successfully received within a predetermined period after transmitting a “Rx path switch response” frame storing information indicating “permission” of acceptance of a path switch.

At this time, in a case where each of the STAs and the AP supports a QoS function, buffering is released to start transmission on the new path only after confirming reception of “Rx path switch response completion” frames with respect to all the ACs (TIDs) for which a “Rx path switch request” has been transmitted.

According to this embodiment, after a path switch request is made from the data receiving side, and a “Rx path switch response” frame is transmitted on the direct link from the data transmitting side and this frame is received on the data receiving side, reception of the last data frame on the existing path is confirmed, and then a “Rx path switch response completion” frame is transmitted to the data transmitting side (STA 1). Further, thereafter, data transmission after a path switch process is performed. Therefore, as shown in FIG. 14, the order of frames received on the data receiving side (STA 2) is set as the order of transmission of data 1 to 6.

While the example described above with reference to FIG. 14 is directed to the case in which the existing path is the AP-routed path and the new path is the direct link path, the present invention is also applicable to a case in which the existing path is the direct link path and the new path is the AP-routed path.

The present invention has been described above in detail with reference to specific embodiments. However, it is obvious that a person skilled in the art can make various modifications to and substitutions for the embodiments without departing from the scope of the present invention. That is, the present invention has been disclosed by way of examples, and should not be construed restrictively. The scope of the present invention should be determined with reference to the appended claims.

The series of processes described in this specification can be executed by hardware, software, or a composite configuration of both. If the processes is to be executed by software, the processes can be executed by installing a program recording the processing sequence into a memory in a computer embedded in dedicated hardware, or by installing the program into a general purpose computer capable of executing various processes. For example, the program can be pre-recorded on a recording medium. Other than being installed into a computer from a recording medium, the program can be received via a network such as the LAN (Local Area Network) or the Internet, and installed into a built-in recording medium such as a hard disk.

The various processes described in this specification may be executed not only time sequentially in the order as they appear in the description but may be executed in parallel or independently depending on the throughput of the device executing the processes. In addition, the term system as used in this specification refers to a logical collection of a plurality of devices, and is not limited to one in which the constituent devices are located within the same housing.

The present application contains subject matter related to that disclosed in Japanese Priority Patent Application JP 2008-208842 filed in the Japan Patent Office on Aug. 14, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A wireless communication device comprising:
a control unit that controls data communication; and
a memory that stores communication data,
wherein
the control unit controls a switch between a direct link path that is a direct communication path with a communication party, and a relay-point-routed path that is a communication path routed via a relay point, and
the control unit transmits a communication path switch request to the communication party, and on condition of reception of an acceptance response from the communication party, the control unit starts data communication using a switched communication path.

2. The wireless communication device according to claim 1,
wherein after transmitting the communication path switch request to the communication party, the control unit accumulates data to be transmitted in the memory, and on condition of reception of an acceptance response from the communication party, the control unit transmits the data to be transmitted which has been accumulated in the memory, via a switched communication path.

3. The wireless communication device according to claim 1,
wherein the control unit transmits a path end frame, which indicates the last data transmitted on a currently used communication path, to the communication party, and transmits the communication path switch request after transmitting the path end frame.

4. The wireless communication device according to claim 1,
wherein the control unit transmits a data frame storing, in its appended header, information indicating the last data transmitted on a currently used communication path, to the communication party, and transmits the communication path switch request after transmitting the data frame.

5. The wireless communication device according to claim 1,
wherein the control unit transmits a data frame storing, in its appended header, information indicating the last data transmitted on a currently used communication path, to the communication party as the communication path switch request, and on condition of reception of an acceptance response from the communication party, the control unit starts data communication using a switched communication path.

6. The wireless communication device according to claim 1,
wherein the control unit transmits the communication path switch request to the communication party by using the direct link path that is the direct communication path with the communication party.

7. A wireless communication device comprising:
a control unit that controls data communication,
wherein
the control unit controls a switch between a direct link path that is a direct communication path with a communication party, and a relay-point-routed path that is a communication path routed via a relay point, and
the control unit returns a path switch acceptance response after receiving a communication path switch request from the communication party, and after returning the path switch acceptance response, the control unit discards a data frame from a path used before the switch.

8. A wireless communication device comprising:
a control unit that controls data communication,
wherein
the control unit controls a switch between a direct link path that is a direct communication path with a communication party, and a relay-point-routed path that is a communication path routed via a relay point, and
the control unit returns a path switch acceptance response after receiving a communication path switch request from the communication party, on condition of reception of an end frame from a path used before the switch, or elapse of a wait time since reception of the communication path switch request.

9. The wireless communication device according to claim 8,
wherein the control unit returns the path switch acceptance response on condition of reception of a data frame storing information indicating an end frame in its appended header.

10. A communication system comprising:
a plurality of wireless communication devices that transmit and receive data, the plurality of wireless communication devices including a first wireless communication device and a second wireless communication device,
wherein
the first wireless communication device transmits a communication path switch request to the second wireless communication device that is a communication party, and starts data transmission using a switched path on condition of reception of an acceptance response from the second wireless communication device, and
the second wireless communication device returns a path switch acceptance response after receiving the communication path switch request from the first wireless communication device, and after returning the path switch acceptance response, the second wireless communication device discards a data frame from a path used before the switch.

11. A communication system comprising:
a plurality of wireless communication devices that transmit and receive data, the plurality of wireless communication devices including a first wireless communication device and a second wireless communication device,
wherein
the first wireless communication device transmits a communication path switch request to the second wireless communication device that is a communication party, and starts data transmission using a switched path on condition of reception of an acceptance response from the second wireless communication device, and
the second wireless communication device returns a path switch acceptance response after receiving the communication path switch request from the first wireless communication device, on condition of reception of an end frame from a path used before the switch, or elapse of a wait time since reception of the communication path switch request.

12. A communication control method which is executed by a wireless communication device, comprising the step of:
controlling a switch between a direct link path that is a direct communication path with a communication party, and a relay-point-routed path that is a communication path routed via a relay point,
wherein the controlling of a switch includes
transmitting a communication path switch request to the communication party, and
starting data transmission using a switched path, on condition of reception of an acceptance response from the communication party.

13. A communication control method which is executed by a wireless communication device, comprising the step of:
controlling a switch between a direct link path that is a direct communication path with a communication party, and a relay-point-routed path that is a communication path routed via a relay point,
wherein the controlling of a switch includes
receiving a communication path switch request from the communication party,
returning a path switch acceptance response, and
discarding a data frame from a path used before the switch, after returning the path switch acceptance response.

14. A communication control method which is executed by a wireless communication device, comprising the step of:
controlling a switch between a direct link path that is a direct communication path with a communication party, and a relay-point-routed path that is a communication path routed via a relay point,
wherein the controlling of a switch includes
receiving a communication path switch request from the communication party, and
returning a path switch acceptance response, on condition of reception of an end frame from a path used before the switch, or elapse of a wait time since reception of the communication path switch request.

15. A program for causing a wireless communication device to execute a communication control, comprising the step of:
causing a control unit to control a switch between a direct link path that is a direct communication path with a communication party, and a relay-point-routed path that is a communication path routed via a relay point,
wherein the controlling of a switch includes
transmitting a communication path switch request to the communication party, and
starting data transmission using a switched path, on condition of reception of an acceptance response from the communication party.

16. A program for causing a wireless communication device to execute a communication control, comprising the step of:
causing a control unit to control a switch between a direct link path that is a direct communication path with a communication party, and a relay-point-routed path that is a communication path routed via a relay point,
wherein the controlling of a switch includes
receiving a communication path switch request from the communication party,
returning a path switch acceptance response, and
discarding a data frame from a path used before the switch, after returning the path switch acceptance response.

17. A program for causing a wireless communication device to execute a communication control, comprising the step of:
causing a control unit to control a switch between a direct link path that is a direct communication path with a communication party, and a relay-point-routed path that is a communication path routed via a relay point,
wherein the controlling of a switch includes
receiving a communication path switch request from the communication party, and
returning a path switch acceptance response, on condition of reception of an end frame from a path used before the switch, or elapse of a wait time since reception of the communication path switch request.
